(19) United States
(12) Patent Application Publication
(10) Pub. No.: US 2026/0236956 A1
(43) Pub. Date: Aug. 13, 2026

(54) Method, System, and Computer Program Product for Asset Valuation with Behavioral Feedback Integration Using Multi-Stage Orchestration

(71) Applicant: Homing Inc., Huntington Beach, CA (US)

(72) Inventor: Dean DiCarlo, Huntington Beach, CA (US)

(21) Appl. No.: 19/415,041

(22) Filed: Dec. 10, 2025

Related U.S. Application Data
(60) Provisional application No. 63/730,053, filed on Dec. 10, 2024.

(51) Int. Cl. G06Q 30/0201; G06Q 40/06

(52) U.S. Cl. CPC G06Q 30/0206; G06Q 40/063

(57) ABSTRACT

A computer-implemented system for real-estate valuation, integrating multi-price prediction models, seller-guidance generation, and skill-based prediction gameplay is disclosed. The system aggregates heterogeneous data including listing attributes, photos, market signals, and user inputs, processed by AI to produce accurate valuation forecasts. The valuation engine employs real-time data and historical trends to predict Days on Market (DOM), optimizing pricing strategies. The game-based component allows users to make mock bids on properties, with outcomes resolved based on actual sale prices. Data from both the market and user interactions continuously refine the system's predictive accuracy and educational content. This invention provides a dynamic, interactive tool for understanding real estate value through continuous feedback loops, ensuring real-time accuracy and actionable insights.

### CROSS-REFERENCE TO RELATED APPLICATION

This application claims priority to U.S. Provisional Patent Application No. 63/730,053, filed Dec. 10, 2024, the entire contents of which are incorporated herein by reference in its entirety.

### BACKGROUND

### 1. Field

The disclosed subject matter relates to computer-implemented systems, methods, and computer program products for operating multimodal data-ingestion pipelines, orchestrated machine-learning workflows, and distributed explainability architectures and, in some particular embodiments or aspects, the subject matter concerns real-time, event-driven computational frameworks and vector-embedding storage mechanisms that support deterministic inference, reduced compute load, and scalable multi-node AI processing and resource-constrained predictive simulations, behavioral-feedback loops for dynamically updating machine-learning components based on aggregated interaction signals.

### 2. Technical Considerations

Existing digital platforms that aggregate property information and produce automated market estimates typically rely on fragmented ingestion pipelines composed of legacy data services, monolithic machine-learning models, and loosely coupled workflow schedulers. These platforms generally process structured records, images, geospatial context, and interaction telemetry in isolated subsystems lacking unified normalization or synchronization layers, resulting in nondeterministic outputs, inconsistent valuations, and substantial recomputation whenever upstream data changes. Because many of these architectures were built around batch-processing paradigms, they frequently exhibit processing latency, redundant feature extraction, and stale model outputs that cannot adapt in real time to rapidly evolving market conditions.

Recent court decisions and settlements involving the National Association of Realtors (NAR) have disrupted long-standing listing-data distribution practices, forcing major listing services and associated digital platforms to modify the structure, availability, and update frequency of their data feeds. These shifts introduce significant technical challenges—including divergent schemas, inconsistent attribute exposure across markets, irregular update intervals, and the removal of previously uniform data-sharing conventions. As a consequence, legacy ingestion and prediction systems—which depend on fixed schemas, periodic batch ingestion, or static assumptions baked into upstream pipelines—experience degraded determinism, increased latency, and cross-market inconsistencies due to their inability to accommodate this dynamically changing data environment.

Although current platforms may provide automated estimates or market-timing predictions, their underlying architectures often employ single-stage inference pipelines that cannot coordinate multi-node analytic workflows or maintain deterministic explainability across distributed compute environments. Explainability mechanisms in such systems typically generate static or text-only summaries and lack support for structured reasoning graphs, deterministic decision objects, narrative scripts, or avatar-based multimodal outputs. As a result, downstream auditing, system validation, and reproducibility are constrained, since current systems cannot produce consistent reasoning traces or verifiable inference pathways.

Many existing systems also rely on conventional data stores that are not optimized for vector-embedding reuse, cross-workflow deduplication, or latency-efficient similarity search. This leads to repeated embedding computation, elevated memory consumption, and degraded throughput under heavy update loads. Similarly, event-driven computation is minimal in the prior art: recalculations frequently depend on scheduled batch jobs instead of real-time triggers, causing delays, stale predictions, and inconsistent behavior across markets and compute clusters.

Interactive or gamified prediction environments, where available, typically operate on static datasets or lagged scoring mechanisms and lack resource-constrained simulation capabilities that synchronize results with real-world outcomes using deterministic computation. Such systems also fail to incorporate behavioral feedback into upstream analytic components in a technically meaningful way that improves model selection, prediction accuracy, or inference stability. Accordingly, there remains a need for an improved computing architecture that unifies multimodal ingestion, orchestrated multi-node AI workflows, deterministic explainability mechanisms, vector-optimized storage, event-driven real-time computation, and adaptive simulation frameworks capable of operating at large scale across heterogeneous and constantly evolving data environments.

### SUMMARY

Accordingly, it is an object of the presently disclosed subject matter to provide systems, methods, and computer program products for automatic supplier management activation deficiencies identified above.

Accordingly, it is an object of the presently disclosed subject matter to provide systems, methods, and computer program products for generating real-time valuations and explainable outputs for an asset based on multimodal data, event-driven orchestration, and reusable vector-embedding representations.

According to non-limiting embodiments or aspects, provided is a computer-implemented method, executed by one or more processors and one or more computer-readable storage devices, for generating real-time valuations and explainable outputs for an asset, the method comprising: ingesting, by a multimodal ingestion module, multimodal asset data comprising structured attributes, one or more images, and contextual geographic information, and transforming the multimodal asset data into a standardized internal schema; identifying, by the multimodal ingestion module or an event-driven orchestration layer, one or more data changes or ingestion events associated with the asset, the data changes comprising at least one of: a newly posted listing, updated images, a price update, a status update, contextual attribute changes, or ingestion of a verified sale price; notifying, by the event-driven orchestration layer, one or more downstream modules that the data changes satisfy one or more trigger conditions requiring processing; executing, by a workflow-orchestration engine, a standardized valuation pipeline comprising: (i) an image-analysis stage configured to generate condition indicators, room-type classifications, and visual-appeal features from the images; (ii) a comparable-selection stage configured to retrieve embeddings from a vector-embedding database and select comparable assets using similarity metrics; and (iii) a prediction stage configured to compute a valuation, a days-on-market (DOM) prediction, and a price-time elasticity surface; generating, by an explainability engine, a structured reasoning object comprising explanation fields describing factors contributing to the valuation, the DOM prediction, and the elasticity surface; validating the structured reasoning object against a deterministic reasoning schema to produce an explainable model output; monitoring, by the event-driven orchestration layer, one or more pipeline states, data states, or model-execution conditions to determine whether an update event necessitates recompilation or recomputation; re-executing, in response to the update event, at least a portion of the valuation pipeline, including reusing stored embeddings when similarity drift satisfies a threshold condition; and outputting, by a dissemination module, an updated explainable valuation package comprising the valuation, the DOM prediction, the elasticity surface, and the explainable model output.

According to non-limiting embodiments or aspects, provided is a system for generating real-time valuations and explainable outputs for an asset, the system comprising: a memory; and at least one processor coupled to the memory and configured to: operate a multimodal ingestion module to receive structured attributes, one or more images, and contextual geographic information for the asset and transform the received data into a standardized internal format; identify, via the multimodal ingestion module or an event-driven orchestration layer, one or more data changes or ingestion events associated with the asset, the data changes comprising at least one of: a newly posted listing, updated images, a price update, a status update, contextual attribute changes, or ingestion of a verified sale price; notify, by the event-driven orchestration layer, one or more downstream modules that the data changes satisfy one or more trigger conditions requiring processing; execute, by a workflow-orchestration engine, a valuation pipeline comprising an image-analysis stage, a comparable-selection stage, and a prediction stage, the prediction stage being configured to compute a valuation, a days-on-market (DOM) prediction, and a price-time elasticity surface; generate, by an explainability engine, a structured reasoning object comprising explanation fields describing factors contributing to the valuation, the DOM prediction, and the elasticity surface; validate the structured reasoning object using a deterministic reasoning schema to produce a validated reasoning object; monitor, by the event-driven orchestration layer, pipeline states, data states, or model-execution conditions to determine whether an update event necessitates recomputation; selectively re-execute, in response to the update event, one or more nodes of the valuation pipeline, including reusing stored embeddings when similarity drift satisfies a threshold condition; and provide, by a dissemination module, an explainable valuation package comprising the valuation, the DOM prediction, the elasticity surface, and the validated reasoning object.

According to non-limiting embodiments or aspects, provided is a non-transitory computer-readable medium or computer program product having instructions stored thereon that, when executed by one or more processors of a computing system, cause the computing system to: ingest multimodal asset data comprising structured attributes, images, and contextual information; transform the multimodal asset data into a standardized internal schema; generate embeddings from the standardized internal schema and store the embeddings in a vector-embedding database; execute a valuation pipeline comprising image analysis, comparable selection, valuation computation, DOM prediction, and elasticity modeling; generate a structured reasoning object describing factors influencing the valuation outputs; validate the structured reasoning object using a deterministic schema to obtain a validated reasoning object; detect an update event associated with the asset or a competitive asset; re-execute at least a portion of the valuation pipeline using at least one reused embedding when similarity drift satisfies a threshold condition; and output an explainable valuation package comprising updated valuation information and the validated reasoning object.

In various non-limiting embodiments or aspects, the methods, systems, and computer program products disclosed herein are configured to operate in real time or near real time to update valuations and associated explainable outputs responsive to detected data changes, while leveraging reusable embedding representations, structured reasoning objects, and deterministic validation to provide transparent and auditable valuation logic.

Further non-limiting embodiments or aspects are set forth in the following numbered clauses:
Clause 1. A computer-implemented method, executed by one or more processors and one or more computer-readable storage devices, for generating real-time valuations and explainable outputs for an asset, the method comprising: ingesting, by a multimodal ingestion module, multimodal asset data comprising structured attributes, one or more images, and contextual geographic information, and transforming the multimodal asset data into a standardized internal schema; identifying, by the multimodal ingestion module or an event-driven orchestration layer, one or more data changes or ingestion events associated with the asset, the data changes comprising at least one of: a newly posted listing, updated images, a price update, a status update, contextual attribute changes, or ingestion of a verified sale price; notifying, by the event-driven orchestration layer, one or more downstream modules that the data changes satisfy one or more trigger conditions requiring processing; executing, by a workflow-orchestration engine, a standardized valuation pipeline comprising: (i) an image-analysis stage configured to generate condition indicators, room-type classifications, and visual-appeal features from the images; (ii) a comparable-selection stage configured to retrieve embeddings from a vector-embedding database and select comparable assets using similarity metrics; and (iii) a prediction stage configured to compute a valuation, a days-on-market (DOM) prediction, and a price-time elasticity surface; generating, by an explainability engine, a structured reasoning object comprising explanation fields describing factors contributing to the valuation, the DOM prediction, and the elasticity surface; validating the structured reasoning object against a deterministic reasoning schema to produce an explainable model output; monitoring, by the event-driven orchestration layer, one or more pipeline states, data states, or model-execution conditions to determine whether an update event necessitates recomputation; re-executing, in response to the update event, at least a portion of the valuation pipeline, including reusing stored embeddings when similarity drift satisfies a threshold condition; and outputting, by a dissemination module, an updated explainable valuation package comprising the valuation, the DOM prediction, the elasticity surface, and the explainable model output.
Clause 2. The method of clause 1, wherein generating embeddings comprises producing image embeddings between 256 and 1024 dimensions and text embeddings between 64 and 512 dimensions.
Clause 3. The method of any one of clauses 1-2, wherein selecting comparable assets comprises retrieving nearest-neighbor embeddings whose cosine similarity exceeds a configurable threshold.
Clause 4. The method of any one of clauses 1-3, wherein validating the structured reasoning object comprises discarding any reasoning object whose structural-consistency score falls below a predetermined threshold.
Clause 5. The method of any one of clauses 1-4, wherein re-executing the valuation pipeline comprises executing only those nodes whose upstream feature sets changed by more than a configured delta magnitude.
Clause 6. The method of any one of clauses 1-5, wherein the explainability engine generates a narrative explanation aligned to the structured reasoning object.
Clause 7. The method of any one of clauses 1-6, further comprising generating avatar-based video explanations using one or more narrative templates derived from the structured reasoning object.
Clause 8. The method of any one of clauses 1-7, further comprising updating one or more predictive models using behavioral signals from optional gameplay interactions including at least one of accuracy histories, bidding tendencies, or user-bias characteristics.
Clause 9. A system for generating real-time valuations and explainable outputs for an asset, the system comprising: a multimodal ingestion module configured to receive structured attributes, images, and contextual data, and transform the received data into a standardized internal format; one or more machine-learning models configured to generate embeddings from the standardized internal format; a vector-embedding database configured to store the embeddings, maintain version identifiers, and determine whether embedding reuse criteria are satisfied; a workflow-orchestration engine configured to execute a valuation pipeline comprising an image-analysis stage, a comparable-selection stage, and a prediction stage; an explainability engine configured to generate structured reasoning objects and validate the reasoning objects using a deterministic reasoning schema; an event-driven orchestration layer configured to detect data changes, determine whether the data changes satisfy trigger conditions, and selectively re-execute nodes of the valuation pipeline; and a dissemination module configured to output an explainable valuation package comprising a valuation, a DOM prediction, an elasticity surface, and a validated reasoning object.
Clause 10. The system of clause 9, wherein the multimodal ingestion module enriches contextual features including one or more of market-velocity indicators, zoning boundaries, school-zone assignments, or micro-neighborhood identifiers.
Clause 11. The system of any one of clauses 9-10, wherein the vector-embedding database detects embedding drift using version-distance metrics and drift-tolerance thresholds.
Clause 12. The system of any one of clauses 9-11, wherein the workflow-orchestration engine comprises a branching controller configured to skip or execute pipeline stages based on prediction-confidence thresholds or data-completeness metrics.
Clause 13. The system of any one of clauses 9-12, wherein the explainability engine comprises a signal-compression module, a reasoning-synthesis module, and a narrative-alignment module.
Clause 14. The system of any one of clauses 9-13, wherein the event-driven orchestration layer is configured to detect competitive-listing updates within at least one of a geographic radius or a similarity-based retrieval boundary.
Clause 15. The system of any one of clauses 9-14, further comprising a media-generation subsystem configured to synthesize avatar-based video explanations using the validated reasoning object.
Clause 16. The system of any one of clauses 9-15, further comprising a gameplay engine configured to compute scoring outcomes, update player balances, apply penalties for over-predictions, or award acquisitions based on verified sale prices.
Clause 17. A non-transitory computer-readable medium or computer program product storing instructions that, when executed by one or more processors, cause a computing system to: ingest multimodal asset data comprising structured attributes, images, and contextual information; generate embeddings from the multimodal data and store the embeddings in a vector-embedding database; execute a valuation pipeline comprising image analysis, comparable selection, valuation computation, DOM prediction, and elasticity modeling; generate a structured reasoning object describing factors influencing the valuation outputs; validate the structured reasoning object using a deterministic schema; detect an update event associated with the asset or a competitive asset; re-execute at least a portion of the valuation pipeline using at least one reused embedding when similarity drift satisfies a threshold condition; and output an explainable valuation package comprising updated valuation information and the validated reasoning object.
Clause 18. The non-transitory computer-readable medium or computer program product of clause 17, wherein the instructions cause the computing system to generate avatar-based video content aligned with the structured reasoning object.
Clause 19. The non-transitory computer-readable medium or computer program product of any one of clauses 17-18, wherein the instructions cause the computing system to update model weights using aggregated behavioral signals from optional gameplay interactions.
Clause 20. The non-transitory computer-readable medium or computer program product of any one of clauses 17-19, wherein the instructions cause the computing system to compute similarity metrics between embeddings to determine whether embedding reuse or regeneration is required.

Accordingly, it is an additional object of the presently disclosed subject matter to provide methods, systems, and computer program products for event-driven, multimodal, and explainable asset valuation that support real-time or near real-time updates while preserving transparent and auditable reasoning outputs.

These and other features and characteristics of the presently disclosed subject matter, as well as the methods of operation and functions of the related elements of structures and the combination of parts and economies of manufacture, will become more apparent upon consideration of the following description and the appended claims with reference to the accompanying drawings, all of which form a part of this specification, wherein such as reference numerals designate corresponding parts in the various figures. It is to be expressly understood, however, that the drawings are for the purpose of illustration and description only and are not intended as a definition of the limits of the disclosed subject matter. As used in the specification and the claims, the singular form of “a,” “an,” and “the” include plural referents unless the context clearly dictates otherwise.

### BRIEF DESCRIPTION OF THE DRAWINGS

Additional advantages and details of the disclosed subject matter are explained in greater detail below with reference to the exemplary embodiments that are illustrated in the accompanying figures, in which:

FIG. 1 is a block diagram of a non-limiting embodiment of an environment in which methods, systems, and computer program products for unified multimodal ingestion, valuation processing, explainability generation, and gameplay orchestration may be implemented.

FIG. 2 is a flow diagram illustrating a non-limiting embodiment of a property-ingestion, validation, and preprocessing workflow, including data normalization, cleaning, enrichment, and attribute scoring.

FIG. 3 is a diagram of a non-limiting embodiment of a photo-analysis and feature-extraction module including room classification, condition scoring, feature extraction, and image-embedding generation.

FIG. 4 is a diagram of a non-limiting embodiment of a comparative-market-analysis engine including comp selection, comp-tiering logic, adjustment computation, and valuation synthesis.

FIG. 5 illustrates a non-limiting embodiment of a days-on-market prediction engine generating predicted market-time values and price-time elasticity surfaces.

FIG. 6 illustrates a non-limiting embodiment of a list-price-optimization engine including price-time tradeoff curves, seller-goal weighting, and recommended-price output generation.

FIG. 7 is a diagram of a non-limiting embodiment of a vector-embedding and storage architecture including embedding reuse, deduplication, caching, and version tracking.

FIG. 8 is a diagram of a non-limiting embodiment of an event-driven orchestration layer including event detection, workflow triggering, adaptive branching, and recomputation logic.

FIG. 9 is a diagram of a non-limiting embodiment of an explainable-model-output engine including signal compression, structured-reasoning-object creation, narrative generation, and delivery.

FIG. 10 is a flow diagram illustrating a non-limiting embodiment of a user-bid submission workflow including eligibility checks against an overbid allowance and logging of a predicted price.

FIG. 11 is a flow diagram illustrating a non-limiting embodiment of a comparative-market-analysis report-generation workflow and synthesis of supporting data for user-interface presentation.

FIG. 12 is a flow diagram illustrating a non-limiting embodiment of a seller-guidance report workflow integrating valuation outputs, price-time predictions, and competitive-positioning indicators.

FIG. 13 is a block diagram of a non-limiting embodiment of a personality-profiling and preference-weighting module showing input sources, preference extraction, and personalized weighting outputs.

FIG. 14 is a block diagram of a non-limiting embodiment of an event-driven feedback module showing ingestion of real-world sale events and behavioral signals used to retrain core AI models and update system outputs.

FIG. 15 is a flowchart illustrating a non-limiting embodiment of gameplay scoring rules within the market boss game engine including prediction error computation and associated overbid, perfect-bid, and outbid outcomes.

FIG. 16 is a flow chart of a non-limiting embodiment illustrating a prize allocation, contest resolution, and reward distribution workflow.

FIG. 17 is a diagram of a non-limiting embodiment of components of one or more computing devices that may implement elements of the environment of FIGS. 1-16 .

### DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the disclosed subject matter as it is oriented in the drawing figures. However, it is to be understood that the disclosed subject matter may assume various alternative variations and step sequences, except where expressly specified to the contrary. It is also to be understood that the specific devices and processes illustrated in the attached drawings, and described in the following specification, are simply exemplary embodiments or aspects of the disclosed subject matter. Hence, specific dimensions and other physical characteristics related to the embodiments or aspects disclosed herein are not to be considered as limiting unless otherwise indicated.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or like are intended to be open-ended terms. Further, the phrase “based on” is intended to mean “based at least partially on” unless explicitly stated otherwise.

As used herein, satisfying a threshold may refer to a value (e.g., a score, a power consumption, etc.) being greater than the threshold, more than the threshold, higher than the threshold, greater than or equal to the threshold, less than the threshold, fewer than the threshold, lower than the threshold, less than or equal to the threshold, equal to the threshold, etc.

As used herein, the terms “communication” and “communicate” may refer to the reception, receipt, transmission, transfer, provision, and/or the like of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit when at least one intermediary unit (e.g., a third unit located between the first unit and the second unit) processes information received from the first unit and communicates the processed information to the second unit. In some examples, a message may refer to a network packet (e.g., a data packet and/or the like) that includes data. It will be appreciated that numerous other arrangements are possible.

As used herein, the terms “client” and “client device” may refer to one or more client-side devices or systems (e.g., remote from a service or healthcare provider) used to handle a match exception (e.g., a transaction, action, or communication in association with a call to action or other activity associated with a match exception). As an example, a “client device” may refer to one or more devices used by a vendor or supplier, one or more host computers used by a supplier or vendor, one or more mobile devices used by a user, and/or the like. In some non-limiting embodiments or aspects, a client device may be an electronic device configured to communicate with one or more networks and initiate or facilitate transactions. For example, a client device may include one or more computers, portable computers, laptop computers, tablet computers, mobile devices, cellular phones, wearable devices (e.g., watches, glasses, lenses, clothing, PDAs, and/or the like). Moreover, a “client” may also refer to an entity (e.g., a vendor, a supplier, and/or the like) that owns, utilizes, and/or operates a client device for transactions (e.g., for transactions within a supply chain).

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a client device or a mobile device. As an example, a mobile device may include a cellular phone (e.g., a smartphone, standard cellular phone, etc.), a portable computer, a wearable device (e.g., watches, glasses, lenses, clothing, and/or the like), a personal digital assistant (PDA), and/or other such as devices. A computing device may also be a desktop computer or other form of non-mobile computer.

As used herein, the term “server” may refer to one or more computing devices (e.g., processors, storage devices, similar computer components, and/or the like) that communicate with client devices and/or other computing devices over a network (e.g., a public network, the Internet, a private network, and/or the like) and, in some examples, facilitate communication among other servers and/or client devices. It will be appreciated that various other arrangements are possible. As used herein, the term “system” may refer to one or more computing devices or combinations of computing devices (e.g., processors, servers, client devices, software applications, components of such, and/or the like). Reference to “a device,” “a server,” “a processor,” and/or the like, as used herein, may refer to a previously-recited device, server, or processor that is recited as performing a previous step or function, a different server or processor, and/or a combination of servers and/or processors. For example, as used in the specification and the claims, a first server or a first processor that is recited as performing a first step or a first function may refer to the same or different server or the same or different processor recited as performing a second step or a second function.

As used herein, the term “asset” may refer to any item, property, or thing for which a value, price trajectory, and/or time-to-sale (or time-to-disposition) may be estimated using computational models. In some examples, an asset may include a parcel of real property (e.g., a residential home, condominium, townhouse, apartment, commercial building, mixed-use property, land parcel, etc.), a movable asset (e.g., a vehicle, boat, recreational asset, or similar item), or any other item that can be listed, marketed, and transacted in a marketplace. As used herein, the terms “subject asset” or “subject property” may refer to the particular asset for which a valuation, pricing recommendation, time-to-sale prediction, or gameplay prediction is being generated by the system.

As used herein, the terms “multimodal data” or “multimodal signals” may refer to data associated with an asset or marketplace that include two or more heterogeneous data types, such as structured tabular data (e.g., numerical and categorical fields), unstructured or semi-structured data (e.g., text descriptions, free-form notes), image data (e.g., photos, frames extracted from video), geospatial data (e.g., coordinates, polygons, geohashes), temporal data (e.g., event timestamps, price-history series), and behavioral data (e.g., gameplay interactions, user engagement metrics, sentiment signals, or other user-generated actions). In some examples, multimodal data may be transformed into one or more standardized internal representations (e.g., normalized features, embeddings, or vectors) suitable for processing by machine-learning models, vector-search engines, workflow-orchestration components, or reasoning engines described herein.

As used herein, the terms “embedding” or “vector embedding” may refer to a numerical representation (e.g., an ordered sequence or vector of real numbers) generated from input data such as images, text, structured asset attributes, behavioral logs, or combinations thereof, where the numerical representation captures semantic or statistical relationships useful for similarity comparison, clustering, retrieval, or downstream modeling. In some examples, an embedding may be produced by a machine-learning model (e.g., a neural network, transformer model, or other feature extractor) and stored in a vector database or similar high-dimensional index. Embeddings may represent, by way of non-limiting example, visual style and condition of an asset, structural similarity among properties, pricing-elasticity surfaces, reasoning outputs, or behavioral patterns, and may be used to perform operations such as k-nearest-neighbor search, deduplication, anomaly detection, or reuse of previously computed intermediate results.

As used herein, the term “vector database” may refer to one or more computer-implemented storage systems configured to persist, index, and retrieve high-dimensional embeddings or vectors associated with assets, analytical outputs, user behavior, or other internal signals. A vector database may support operations such as similarity search (e.g., k-nearest-neighbor queries), clustering, deduplication based on distance thresholds, and versioning of embeddings corresponding to different model versions or workflow states. In some examples, the vector database may be used to detect redundant computations, skip previously solved subproblems, retrieve historical reasoning objects, or maintain cross-market consistency by aligning new computations with prior embeddings stored for related assets or events.

As used herein, the term “Workflow Orchestration Engine” may refer to a computer-implemented control layer that models, schedules, and executes a set of analytical, reasoning, and output nodes as a directed graph or workflow. The Workflow Orchestration Engine may coordinate the flow of multimodal data through discrete nodes such as data-ingestion nodes, photo-analysis nodes, comparative-analysis nodes, valuation nodes, Days-on-Market prediction nodes, list-price optimization nodes, explainability nodes, and gameplay-integration nodes. In some examples, the Workflow Orchestration Engine supports conditional execution, parallel execution, event-driven re-execution, dependency resolution, and caching or reuse of intermediate results, thereby reducing redundant computation, improving latency, and enabling deterministic and auditable execution patterns across distributed compute resources.

As used herein, the term “JET Multi-Node Reasoning Engine” (or “JET”) may refer to a staged, computer-implemented reasoning subsystem configured to transform structured analytical outputs into deterministic reasoning objects, narrative content, and script material for avatar-based or other explainable outputs. Rather than issuing a single free-form prompt to a language model, the JET Multi-Node Reasoning Engine may decompose reasoning into multiple specialized nodes (e.g., signal-synthesis nodes, core reasoning nodes, validation nodes, and content-creation nodes) that enforce schema constraints, perform logical consistency checks, and separate valuation logic from narrative styling. In some examples, JET receives compressed reasoning inputs (e.g., valuation embeddings, DOM curves, price-time surfaces, seller-preference vectors, behavioral signals), generates machine-readable reasoning objects (e.g., structured JSON with explanations and factor rankings), validates such reasoning, and then produces narrative text or scripts. This architecture may reduce hallucination risk, improve determinism, lower inference cost, and maintain version-stable reasoning across model updates.

As used herein, the term “Market Boss gameplay engine” may refer to a computer-implemented gameplay subsystem configured to run skill-based prediction contests in which users submit mock bids or predictions for asset outcomes (e.g., sale prices, time-to-sale), subject to resource constraints and contest rules. In some examples, the Market Boss gameplay engine may allocate a gameplay resource such as an Overbid Allowance, apply Perfect Bid and Trade Up mechanics, track portfolio performance, compute contest scores and leaderboard positions, and resolve contest outcomes against verified real-world transaction data (e.g., closing prices and dates). The gameplay engine may interact with valuation, DOM, optimization, and explainability subsystems to generate game rounds, scoring logic, and educational content, and may further emit gameplay-derived behavioral signals used to improve or recalibrate analytical models.

As used herein, the terms “Allowance” or “Overbid Allowance” may refer to a gameplay-specific resource or budget associated with a user or contest participant that is debited or otherwise consumed when the user places predictions or mock bids above actual realized outcomes (e.g., overbids relative to verified sale prices). In some examples, Overbid Allowance may be initialized at the start of a contest, reduced when overbids occur, optionally replenished through achievements or tasks (e.g., educational tasks, referrals, in-person check-ins), and used as an input to scoring logic and portfolio evaluation. The design of Overbid Allowance may enforce resource constraints that encourage strategic bidding behavior, differentiate skillful predictions from random guesses, and provide additional behavioral signals for the system's analytics and model-training components.

As used herein, the term “behavioral signal” may refer to any data element, feature, or vector derived from user interactions with the system, including but not limited to gameplay actions (e.g., bid amounts, timing of bids, property selections, streak accuracy), engagement with educational or explanatory content (e.g., video completion, changes in accuracy after viewing explanations), user navigation patterns, contest participation, or in-person event interactions. In some examples, behavioral signals may be processed into behavioral embeddings or statistically weighted features that represent user sentiment, perceived value ranges, risk tolerance, neighborhood preferences, or other behavioral patterns. These behavioral signals may be stored in one or more databases (e.g., a vector database) and used to refine comparable-property selection, DOM modeling, price-elasticity surfaces, list-price optimization, and narrative emphasis.

As used herein, the term “behavioral feedback loop” may refer to a closed-loop process in which behavioral signals derived from user interactions (e.g., gameplay outcomes, bidding patterns, sentiment indicators, or learning responses) are reintroduced into one or more analytical models or workflows to improve predictive accuracy, calibration, and system performance over time. In some examples, a behavioral feedback loop may include capturing gameplay data, transforming such data into structured features or embeddings, updating model parameters or weights, recalibrating valuation or DOM models, and subsequently exposing updated predictions or explanations to users, thereby generating new behavioral responses. This iterative cycle allows the system to adapt to emerging patterns, detect shifts in perceived value or market sentiment earlier than traditional systems, and provide improved technical performance through continuous model refinement.

As used herein, the term “Days-on-Market (DOM) prediction engine” may refer to a subsystem configured to compute predicted time-to-sale (e.g., expected number of days on a market or platform) across one or more hypothetical asking prices or listing strategies. In some examples, the DOM prediction engine may ingest inputs such as valuation outputs, historical sales, market-velocity indicators, seasonality factors, competitive-listing signals, condition embeddings, and seller disposition parameters, and may generate DOM curves, sell-through probabilities, and price-velocity relationships that are stored as structured data and/or embeddings. These outputs may be used by list-price optimization modules, gameplay scoring logic, explainability subsystems, or feedback loops to provide price-time tradeoff insights and to update models as new sale outcomes occur.

### Embeddings and Similarity Structures

As used herein, the terms “embedding” or “vector embedding” may refer to a numerical representation generated from input data such as images, text, structured fields, or behavioral logs, where the representation captures semantic or statistical relationships useful for similarity search, clustering, ranking, or downstream modeling. Embeddings may be generated by one or more machine-learning models and stored in a high-dimensional index for reuse, deduplication, or comparative analysis. In some examples, an embedding may include between 64 and 4096 dimensions, preferably between 256 and 1024 dimensions; may be represented in FP16 or FP32 precision; may be considered similar when cosine similarity exceeds 0.90-0.95; and may be treated as unchanged for reuse when drift remains within ±2-5% normalized distance.

As used herein, the term “vector database” may refer to one or more computer-implemented storage systems configured to persist, index, and retrieve embeddings using similarity-search operations or approximate-nearest-neighbor methods. A vector database may maintain associations between embeddings and the source entities, intermediate workflow outputs, or model versions that produced them. In some examples, a vector database may contain between 10⁵ and 10⁸ stored vectors; may return nearest-neighbor results in ≤5-15 milliseconds; may support recall levels of at least 90-98%; and may refresh or invalidate stored embeddings when similarity to updated embeddings falls below 0.85-0.92 or when drift exceeds 0.05-0.15 normalized distance.

### Workflow Systems and Execution Control

As used herein, the term “Workflow Orchestration Engine” may refer to a computer-implemented system configured to schedule, execute, and coordinate analytic, predictive, generative, or reasoning tasks arranged as a directed graph or directed acyclic workflow. The orchestration engine may manage dependencies, node-level execution order, parallel execution, conditional branching, and deterministic reprocessing triggered by events or data updates. In some examples, the engine may support 16-512 concurrently executable nodes, preferably 32-128; may enforce node-execution windows of 10 milliseconds to 2 seconds; may trigger recalculation when valuation changes exceed 3%, DOM predictions change by at least 5 days, or sentiment indicators vary by at least 0.1; and may re-execute portions of the workflow every 1-30 seconds, preferably every 5-10 seconds, when event-driven updates occur.

As used herein, the term “event-driven orchestration” may refer to the automatic triggering or re-triggering of one or more workflow nodes in response to a change in data, asset attributes, marketplace conditions, or system state. Triggers may include ingestion of new images, listing updates, changes in competitive conditions, or arrival of verified transaction outcomes. In some examples, event triggers may fire when input deltas exceed configured thresholds such as ≥3% valuation shift, ≥5-point sizzle score change, ≥0.1 sentiment shift, or new comparable-property availability within a defined radius or similarity range.

As used herein, the term “adaptive workflow branching” may refer to modifying or selecting a processing path based on detected context, data quality, prediction confidence, behavioral patterns, or model outputs. Branching may include selecting a more compute-intensive image-analysis mode, skipping a valuation step due to confidence thresholds, or applying alternative reasoning templates. In some examples, adaptive branching may be activated when confidence falls below 0.70-0.85, when data completeness is under 80-95%, or when intermediate-signal divergence rises above 5-10%.

### Explainability, Jet Reasoning, and Model Interpretation

As used herein, the term “JET Multi-Node Reasoning Engine” may refer to a staged reasoning subsystem configured to transform model outputs into structured reasoning objects, validated explanation schemas, and narrative-ready representations. The JET engine may include nodes for signal compression, factor synthesis, schema validation, and narrative conversion, each governed by explicit templates or rule sets to ensure consistency, reproducibility, and deterministic behavior. In some examples, a reasoning schema may contain 8-64 fields, preferably 16-32; may achieve structural-consistency scores of at least 0.90; may tolerate contradiction rates no greater than 5%; may reduce unstructured reasoning entropy by 40-60%; and may constrain narrative segments to between 50 and 500 tokens, preferably 75-200 tokens.

As used herein, the term “structured reasoning object” may refer to a machine-readable data structure that expresses explanatory content derived from analytic outputs, including factor rankings, importance measures, causal or semi-causal narratives, key feature contributions, and contextual constraints. Structured reasoning objects may be generated, validated, stored, and later converted into narrative or video-compatible form. In some examples, a reasoning object may include between 10 and 50 explanatory elements, preferably 15-30; may be considered valid when compliance with schema constraints exceeds 90-95%; and may be reused when the associated asset or model version changes remain within a defined tolerance such as ≤2-4% valuation shift or ≤5% DOM shift.

As used herein, the term “Explainable Model Output Engine” may refer to one or more subsystems configured to transform structured reasoning objects into narrative outputs, textual summaries, recommendations, or inputs for avatar-based video generation. The engine may perform signal selection, content alignment, template application, language-model refinement, and formatting. In some examples, the engine may select 5-50 explanatory factors, preferably 10-25; may generate narrative outputs between 200 and 1500 tokens, preferably 350-750 tokens; and may include only factors contributing at least 1-3% to a modeled outcome.

### Media Generation and Avatar-Based Output

As used herein, the term “media-generation subsystem” may collectively refer to avatar-generation modules, background-generation modules, motion-prompt engines, and video-synthesis interfaces configured to render narrative outputs into audiovisual content. The subsystem may support template-based avatars, prompt-driven background scenes, synchronized gestures, and multimodal content delivery aligned with structured reasoning objects.

As used herein, the term “avatar-generation module” may refer to components configured to generate or select virtual characters that present narrative or explanatory content. Avatars may be parameterized using style vectors, persona profiles, or scene constraints. In some examples, style vectors may include 16-256 dimensions, preferably 32-128; avatars may be rendered in 720 p-4K resolution, preferably 1080 p; and avatar sets may be limited to 2-12 persona families for consistency and performance.

As used herein, the term “motion-prompt module” may refer to components configured to transform narrative scripts into structured gesture, animation, or pose metadata for avatar rendering. Motion prompts may align with semantic emphasis, sentence structure, or timing cues. In some examples, motion prompts may align frames at 50-200 millisecond granularity, preferably 100 milliseconds; may generate 0.5-2.5 gestures per second, preferably 0.8-1.6; and may constrain pose transitions to maintain natural-appearing motion.

As used herein, the term “video-synthesis interface” may refer to components configured to combine avatar renderings, background scenes, narrative scripts, timing metadata, and motion prompts into synchronized video output. In some examples, the interface may generate videos 5-120 seconds in length, preferably 15-45 seconds; may synchronize lip motion within 20-40 milliseconds; and may render frames at 24-60 fps, preferably 30 fps.

### Valuation, Prediction, and Optimization Systems

As used herein, the term “Comparative Market Analysis (CMA) engine” may refer to components configured to identify, filter, rank, and adjust comparable assets for valuation. The CMA engine may incorporate embeddings, condition signals, feature-level adjustments, and similarity metrics to compute valuation ranges. In some examples, comparable-candidate pools may include 10-200 assets, preferably 20-60; similarity thresholds may range from 0.80-0.95; and adjustment factors may be limited to ±1-20%, preferably ±3-10%.

As used herein, the term “Days-on-Market (DOM) prediction engine” may refer to components configured to compute expected time-to-sale values under varying price scenarios or listing strategies. DOM predictions may incorporate temporal features, competitive conditions, valuations, condition indicators, and behavioral signals. In some examples, the DOM engine may evaluate 8-64 price points, preferably 12-24; may generate forecasts over 5-50 horizons; and may trigger recalculation when DOM shifts by at least 5-10%.

As used herein, the term “price-time elasticity surface” may refer to a multidimensional representation mapping price inputs to predicted sale probabilities, expected DOM, or utility functions. In some examples, elasticity surfaces may include 8-64 pricing intervals, preferably 12-24; may evaluate 5-50 time horizons; may classify high-elasticity regions where DOM changes ≥10-20% per 1% price change; and may classify stable regions where DOM shifts ≤3% across ±2% price adjustments.

As used herein, the term “list-price optimization engine” may refer to components configured to generate recommended listing strategies based on valuation, DOM predictions, seller goals, and risk preferences. In some examples, the engine may evaluate 20-200 pricing scenarios, preferably 40-120; may require sell-through probabilities of at least 70-90%; and may constrain recommendations within ±3-5% of baseline valuation.

### Gameplay, Rewards, and Behavioral Feedback

As used herein, the term “Market Boss gameplay engine” may refer to components configured to operate skill-based prediction contests. The engine may manage contest rounds, resource constraints, scoring logic, portfolio states, leaderboards, and reveal events based on real-world outcomes. In some examples, portfolios may include 3-20 assets, preferably 5-12; scoring multipliers may range from 1.0× to 5.0×; and contests may resolve within 1-30 days of underlying outcome confirmation.

As used herein, the term “Overbid Allowance” may refer to a resource deducted when predictions exceed realized outcomes. In some examples, Allowance may range from $1,000 to $25,000, preferably $5,000-$15,000; may replenish by 5-20%; and may be exhausted when overbidding exceeds configured thresholds.

As used herein, the term “Perfect Bid outcome” may refer to a condition in which a participant's prediction satisfies one or more stipulated accuracy requirements. In some examples, accuracy may require being within ±0.5-2.0% of realized value, preferably ±1%; and Perfect Bids may award multipliers of 1.0×-5.0×, preferably 1.5×-3.0×.

As used herein, the term “Trade Up mechanic” may refer to gameplay rules allowing replacement or adjustment of a portfolio element under specified conditions. In some examples, Trade Up actions may incur costs equal to 5-25% of remaining Allowance, preferably 10-15%; and may be limited to 1-5 uses per contest, preferably 2-3.

As used herein, the term “reveal pipeline” may refer to components that resolve pending predictions when outcome data becomes available. In some examples, the reveal pipeline may detect new outcomes within 1-10 minutes; may compute results in ≤50-200 milliseconds; and may trigger downstream recalibration within 5-60 minutes.

As used herein, the term “behavioral signal” may refer to any measurable feature derived from gameplay or user interaction, including bid tendencies, timing patterns, accuracy trends, responses to explanations, and sentiment indicators. In some examples, behavioral embeddings may include 32-256 dimensions; updates may be triggered when prediction error shifts ≥3% or when bias exceeds 1.5 standard deviations; and recency weighting may apply exponential decay factors of 0.90-0.99, preferably 0.95.

As used herein, the term “behavioral feedback loop” may refer to a process in which aggregated behavioral signals recalibrate models or downstream components. In some examples, updates may occur every 1-24 hours, preferably every 4-6 hours; may require 50-500 new samples, preferably ≥200; and may trigger earlier when model drift exceeds 2-5%.

As used herein, the term “model-control parameters” may refer to configurable numerical or logical settings that govern the operation of one or more machine-learning models used within the system, including models for valuation generation, days-on-market prediction, list-price elasticity estimation, or photo-based feature extraction. Model-control parameters may include, for example, embedding dimensionality values, smoothing constants, decay coefficients, learning-rate schedules, classification-confidence thresholds, feature-weighting profiles, or parameters defining model-specific gating, pooling, or ensemble-selection operations. Adjusting model-control parameters may alter model accuracy, determinism, computational efficiency, or responsiveness to real-estate market changes. In some embodiments, model-control parameters have preferred ranges, such as embedding dimensions of 64-1024, smoothing factors of 0.1-0.9, or confidence thresholds between 0.50 and 0.98, although other ranges may be used depending on implementation.

As used herein, the term “valuation-constraint parameters” may refer to quantitative limits, thresholds, tolerances, or rule-sets that restrict or shape the numerical outputs of the valuation engine, comparative-market-analysis engine, or list-price optimization engine. Valuation-constraint parameters may include similarity-score thresholds for comparable selection, maximum or minimum adjustment values for comp scaling, acceptable variance ranges for price-stability outputs, or constraint values defining acceptable tradeoffs between predicted days-on-market and recommended list price. In some embodiments, valuation-constraint parameters may include comp-distance radii between 0.1-10 miles, comp-adjustment limits between ±1-20 percent, and similarity-score cutoffs between 0.70 and 0.95, although the invention is not limited to these examples.

As used herein, the term “market-state parameters” may refer to one or more dynamic indicators, metrics, indices, or computed factors representing the current or evolving state of one or more real-estate markets. Market-state parameters may include, for example, market-velocity indices, liquidity measures, price-acceleration rates, inventory-pressure metrics, sale-to-list-ratio trends, or volatility coefficients derived from historical and real-time data. Changes in market-state parameters may be used to trigger event-driven recalculations, workflow branching, valuation re-synthesis, or DOM-curve regeneration. In some embodiments, market-state parameters may fall within normalized ranges such as 0-1, 0-100, or −1 to +1 depending on the metric, and may be updated on an hourly, daily, or event-driven basis.

As used herein, the term “explainability-consistency parameters” may refer to rules, thresholds, or conditions governing the determinism, internal consistency, logical correctness, or narrative coherence of explanation outputs generated by the explainability engine (e.g., the JET system). Explainability-consistency parameters may include, for example, thresholds for signal-compression fidelity, requirements for non-contradictory reasoning objects, ordering rules for multi-node explanation graphs, or permissible ranges for attribution-score variance across model outputs. In some embodiments, explainability-consistency parameters may include determinism thresholds between 0.90 and 0.999, attribution-variance limits between 1-15 percent, or minimum compression-fidelity values between 0.80 and 0.98, although other values may be used.

The systems and methods described herein are presented in the context of real-estate valuation, pricing optimization, explainability generation, and prediction-based gameplay; however, the disclosed platform may be applied to a broad range of other asset classes where multimodal signals, temporal dynamics, and market conditions interact. Examples include automotive assets, commercial equipment, collectibles, rental markets, and other domains where asset condition, imagery, market velocity, and behavioral indicators influence valuation accuracy and time-to-transaction predictions. In each of these contexts, the ability to unify multimodal ingestion, run orchestrated valuation workflows, generate deterministic explanations, and recalculate predictions in real time provides improvements in consistency, precision, and computational efficiency over existing systems.

As described above, prior-art systems suffer from a fragmented and static approach to valuation and prediction. Traditional automated valuation models operate on narrow structured datasets, lack real-time recalculation, and typically ignore photographic condition, localized competitive dynamics, and seller-goal modeling. Manual or agent-centric valuation processes introduce further variability, inconsistency, and latency, particularly as centralized listing rules and compensation structures evolve due to regulatory and judicial developments that reduce reliance on historical broker-driven frameworks. Existing systems also lack deterministic explainability; their outputs are often opaque, difficult to audit, and dependent on non-reproducible model behaviors. Moreover, current approaches provide no unified mechanism for leveraging large-scale behavioral signals—such as user predictions, bidding tendencies, and gameplay performance—to refine model calibration or comp-selection logic.

These limitations create significant inefficiencies, including delayed updates, inconsistent reasoning, inability to incorporate real-time market events, and absence of cross-modal normalization. Existing architectures also suffer from computational inefficiency, re-computing large portions of the workflow unnecessarily due to the absence of vector-embedding reuse, deduplication, adaptive branching, or event-driven orchestration. The lack of integrated reasoning frameworks further prevents downstream narrative generation, multi-format explanation delivery, or synchronized avatar-based video outputs.

The present disclosure addresses these deficiencies by providing a unified, computer-implemented platform configured for multimodal ingestion; image and feature analysis; similarity-based comp selection; dynamic pricing and market-time prediction; multi-node deterministic reasoning; real-time event-driven recalculation; and multi-market gameplay that produces behaviorally rich signal feedback. The disclosed system leverages vector databases for embedding reuse, event-driven triggers for updating valuations in real time, and a multi-node explainability architecture (JET) that generates structured reasoning objects suitable for text, interface, and video outputs. This architecture improves reproducibility, reduces computational overhead, increases transparency, and enables multi-market scalability. Additionally, the system incorporates gameplay-derived behavioral feedback that refines comp selection, improves elasticity-surface estimation, and enhances DOM forecasting beyond what purely transactional data can achieve.

Through this integration of multimodal ingestion, orchestrated AI workflows, structured explainability, and behavioral feedback, the disclosed system yields improvements in valuation accuracy, reasoning consistency, computation efficiency, interpretability, and responsiveness. Real-time recalculation ensures that predictions remain current as listings update, competitive properties emerge, or market velocity shifts. Structured reasoning objects and deterministic nodes provide stable, reproducible explanations suitable for regulatory, consumer-facing, and audit contexts. Behavioral signals collected through skill-based gameplay improve model adaptation and predictive calibration across regions and asset categories. These combined improvements represent a technical advancement over traditional valuation engines, content-generation systems, and predictive-gaming platforms.

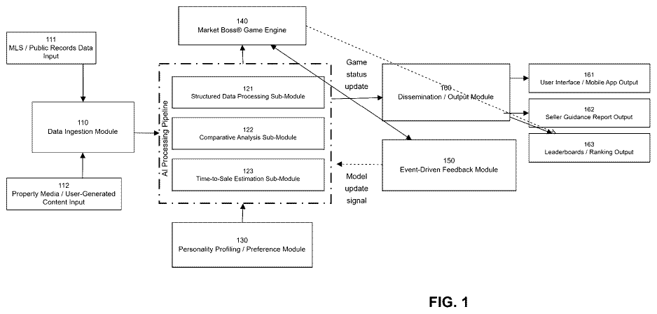

FIG. 1 illustrates a non-limiting embodiment of a system architecture 100 configured to perform unified multimodal data ingestion, automated valuation analysis, structured explainability generation, event-driven recalculation, and optional skill-based prediction gameplay. As shown in FIG. 1, the architecture includes a data ingestion module 110, a central AI/valuation engine 120 (with sub-modules 121, 122, 123), a vector-embedding database, a Market Boss® game engine 140, an event-driven feedback module 150, and a dissemination/output module 160.

In some examples, system architecture 100 includes a data ingestion module 110 configured to receive the multimodal asset data recited in the claims, including structured attributes, images, videos, panoramic media, user-generated content, and contextual geographic information. Data ingestion module 110 transforms such heterogeneous inputs into standardized internal representations required by subsequent pipeline stages. This transformation supports the claimed processing steps by producing the inputs used to generate embeddings, enabling consistent comparable-selection logic, and ensuring that downstream valuation components operate on coherent, normalized data.

In some embodiments, system architecture 100 further includes a central AI/valuation engine 120 configured to perform the multi-stage valuation pipeline recited in the claims. The feature-extraction and photo-analysis module 121 computes condition signals, room-type classifications, material and renovation indicators, and visual-appeal attributes from the one or more images. Module 121 generates the image embeddings referenced in the claims, which are stored in the vector-embedding database and later used for comparable selection and inference reuse.

The comparable-selection and market-timing module 122 retrieves embeddings from the vector store, performs similarity-based retrieval as claimed, selects comparable assets, computes valuation estimates, generates days-on-market predictions, and constructs price-time elasticity surfaces. These processes correspond directly to claimed stages (i), (ii), and (iii) of the multi-stage valuation pipeline. The outputs of module 122 form the valuation, DOM prediction, and elasticity surfaces recited in the independent claims.

The explainability and reasoning module 123 generates the structured reasoning object explicitly required by the claims. Module 123 synthesizes analytical signals, compresses model outputs into interpretable explanation fields, and validates the reasoning object using deterministic schemas as recited. Successful validation produces the explainable model output incorporated into the updated explainable valuation package. In some embodiments, module 123 additionally generates avatar-based or narrative-ready representations of the reasoning object, consistent with the dependent claims.

In some examples, system architecture 100 includes a vector-embedding database configured to store embeddings generated by modules 121 and 123. The vector store maintains version histories, detects embedding drift, and determines whether embeddings satisfy reuse thresholds required for selective recomputation. These operations correspond to the reuse logic, drift-threshold determination, and selective re-execution functionality recited in the claimed method and system.

In some embodiments, system architecture 100 includes a Market Boss® game engine 140 configured to support optional contest or gameplay functionality described in the dependent claims. While not required for the core claimed subject matter, game engine 140 may consume valuation and explainability outputs, compute scoring outcomes, update user balances or allowances, determine perfect-bid or overbid outcomes, and record behavioral signals used to retrain model components within valuation engine 120. These gameplay operations remain optional and do not limit the valuation, explainability, or event-driven recomputation mechanisms described in the independent claims.

In some embodiments, system architecture 100 includes an event-driven feedback module 150 configured to detect the update events expressly recited in the claims, including price changes, status changes, ingestion of new images, competitive-listing activity, or ingestion of verified sale prices. Upon detecting such an event, module 150 determines which parts of the valuation pipeline must be re-executed and triggers selective recomputation of modules 121, 122, and 123 based on similarity-drift thresholds or upstream input deltas. This corresponds directly to the claimed steps of detecting an update event and re-executing at least a portion of the pipeline using stored embeddings when reuse criteria are satisfied. Module 150 ensures deterministic state transitions and synchronized updates across valuation, explainability, and gameplay pathways.

In some embodiments, system architecture 100 includes a dissemination and output module 160 configured to assemble and output the updated explainable valuation package recited in the claims. This package may include the valuation, DOM prediction, elasticity surface, validated reasoning object, and optionally, avatar-generated content, graphical explanations, or gameplay outputs. Dissemination module 160 supports real-time streaming of updates to web interfaces, mobile devices, partner systems, or other client endpoints.

In some non-limiting embodiments or aspects, system 100 may operate in a distributed or cloud-native environment using event streams, message queues, or microservice interfaces. Such architecture supports the claimed state-governance and selective recomputation features, enabling each module to operate on coherent and versioned state representations and permitting efficient invalidation and regeneration of dependent states.

In some embodiments, system architecture 100 is deployable across various hardware and user-interface environments, including mobile applications, desktop browsers, gaming consoles, AR/VR systems, NFC-enabled kiosks, and interactive displays. These embodiments illustrate alternative operational contexts for executing the claimed methods and computer-program instructions without altering the underlying logic or technical processes of the valuation and explainability pipeline.

In some embodiments, the system may be applied to assets beyond real estate, including vehicles, collectibles, digital assets, or other items benefiting from multimodal valuation, explainability, and event-driven recalculation. Such embodiments demonstrate the generality of the claimed subject matter without limiting its scope.

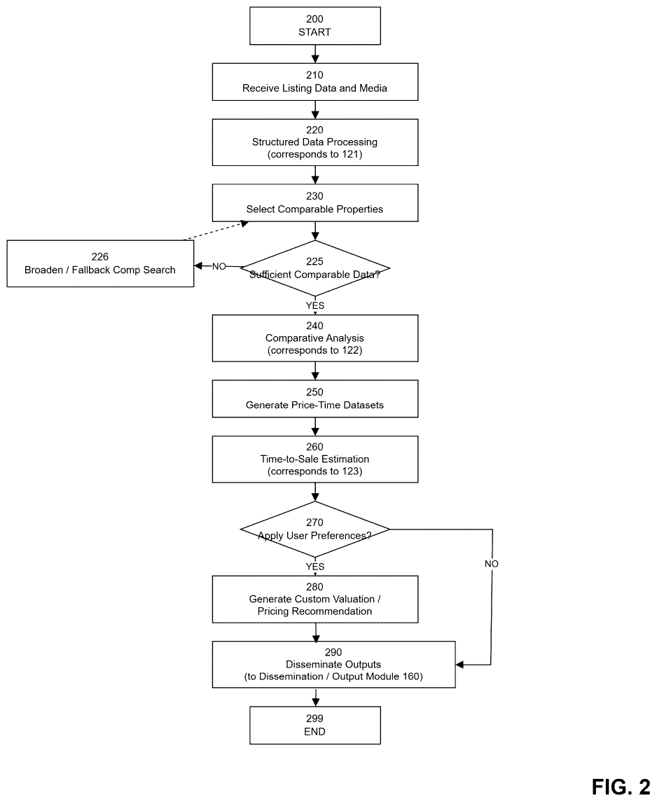

FIG. 2 is a diagram of a non-limiting embodiment of a workflow 200 for generating real-time valuations, explainable outputs, and optional prediction-contest outcomes for an asset. Workflow 200 includes a sequence of functional stages which may be executed completely or partially by one or more components of system architecture 100, including Data Ingestion Module 110, Central AI/Valuation Engine 120, Photo/Feature Analysis Module 121, Comparable-Selection and Prediction Module 122, Explainability Module 123, Market Boss® Game Engine 140, Event-Driven Feedback Module 150, and Dissemination/Output Module 160. As an example, external listing services, transaction feeds, imaging systems, or user devices provide additional inputs that participate in one or more stages of workflow 200.

Referring now to FIG. 2, at step 202, workflow 200 includes ingesting multimodal asset data. As an example, step 202 is performed (e.g., completely, partially, etc.) by one or more components of the system architecture 100 of FIG. 1, including a multimodal ingestion module 110, a photo-analysis module 121, a location-context processor 122, a behavioral-signal processor 123, an event-driven feedback module 150, and a vector-embedding database 170 operating individually or in combination to receive, normalize, and register data associated with an asset (e.g., a real-estate property).

In some non-limiting embodiments or aspects, the multimodal ingestion module 110 receives structured listing attributes and contextual information from external data sources (e.g., listing services, public-record systems, or transactional feeds). These attributes may include property identifiers, list prices, historical sale prices, interior characteristics, exterior characteristics, geospatial coordinates, zoning data, neighborhood descriptors, or market-velocity indicators. The module 110 may further perform normalization operations to reconcile inconsistent field names, resolve conflicting data across sources, or assign a unified internal property identifier for downstream processing.

In some non-limiting embodiments or aspects, the photo-analysis module 121 participates in ingestion by receiving raw interior or exterior photos, normalizing the images (e.g., file format, resolution, metadata handling), and generating first-order photo features such as room-type indicators, condition cues, or visual-quality metrics. These features may be passed to the location-context processor 122, the behavioral-signal processor 123, or the central valuation engine for use in later stages of workflow 200.

In some examples, the location-context processor 122 ingests and aligns geographic features associated with the property (e.g., parcel boundaries, walk-time distances, school assignments, transportation access, or neighborhood-level statistics). The processor 122 may compute derived geographic attributes or context-quality metrics before they are forwarded to other modules for valuation or prediction tasks.

In some non-limiting embodiments or aspects, the behavioral-signal processor 123 ingests interaction logs or user-generated signals (e.g., clickstream velocity, agent activity, buyer engagement metrics, saved-property behavior, or comparative interest trends). These behavioral features may be associated with relevant properties, stored with metadata describing their origin, and prepared for use in determining market sentiment or interest dynamics during subsequent steps.

In some non-limiting embodiments or aspects, ingestion includes deduplicating, reconciling, and timestamping data from multiple ingestion events. The multimodal ingestion module 110 may merge listing data that references the same property from different sources or apply priority rules to determine which source is authoritative for particular fields. All unified records may be stored in association with version identifiers to support recalculation, auditability, and temporal reasoning.

In some non-limiting embodiments or aspects, ingestion includes generating initial embeddings from one or more data types. The system may compute image embeddings, text embeddings, geographic embeddings, or behavioral embeddings and store the resulting vectors within the vector-embedding database 170. The database 170 may apply deduplication checks, drift-detection rules, or version-control logic to determine whether embeddings should be reused, regenerated, or archived.

In some non-limiting embodiments or aspects, ingestion includes registering ingestion events that trigger additional downstream computation. For example, the event-driven feedback module 150 may record events corresponding to listing creation, status changes, price changes, newly available photos, neighborhood-level updates, or updated behavioral signals. These ingestion-related events may later cause the valuation engine, cma engine, or dom engine to re-execute one or more workflow nodes when threshold conditions are met.

In some non-limiting embodiments or aspects, ingestion includes writing both raw and processed forms of multimodal data into storage layers accessible by the central valuation engine, including object stores for media assets, feature stores for derived attributes, and the vector-embedding database 170 for embedding representations. These stored representations become the basis for subsequent steps in workflow 200, including valuation, prediction, explainability, and game-related scoring.

In some non-limiting embodiments or aspects, the data ingestion module 110 receives structured attributes, one or more images, and contextual geographic information from external listing sources, user-uploaded inputs, or historical transaction databases. Upon receipt, the data ingestion module 110 may assign each incoming element a data-version identifier, allowing downstream systems to detect when a previously stored representation has changed. When new or updated data is detected, the module may emit an ingestion-update signal that propagates to one or more nodes of workflow 200.

In some non-limiting embodiments or aspects, the data ingestion module 110 transforms heterogeneous listing formats into a standardized internal schema and stores the standardized inputs in a staging repository for downstream model consumption. Standardization may include (i) normalizing unit types and measurement formats, (ii) converting categorical descriptors into canonical enumerations, (iii) mapping free-text fields to structured tags using deterministic parsing rules, and (iv) resolving conflicting entries using a priority-based arbitration rule (e.g., verified listing-service input overrides user-provided input). When normalization modifies a field, the system may mark the affected attribute as changed and update dependent feature vectors used by the valuation engine 120.

In some non-limiting embodiments or aspects, additional contextual features such as market-velocity indicators, school assignments, zoning constraints, and micro-neighborhood identifiers are automatically associated with the asset. These contextual features may be obtained from external datasets and refreshed at periodic intervals (e.g., hourly, daily, or when a zoning map is republished). The location-context processor 122 may enrich each asset record by computing derived features such as walkability scores, school-quality tiers, or regulatory overlays. When enriched values change, the system may update the asset's contextual feature block and trigger reevaluation of similarity metrics or comparable-selection results.

In some non-limiting embodiments or aspects, ingestion triggers may include detection of a newly posted listing, receipt of updated listing photos, updates to price or status, or entry of a verified sale price. Each trigger may be recorded as an event object containing one or more changed fields and a computed impact score. The event-driven feedback module 150 may analyze the event object to determine which downstream workflow nodes must re-execute (e.g., image-analysis module 121 reruns if new photos arrive; comp-selection reruns if price deltas exceed a threshold; valuation only reruns if core features changed).

In some non-limiting embodiments or aspects, the system may maintain a change-propagation graph that specifies which components depend on which inputs. When ingestion updates occur, this graph determines the minimal recomputation set, thereby avoiding unnecessary reprocessing. For example, updated school-zone boundaries may affect only contextual embeddings but not condition-signal embeddings, enabling selective regeneration.

In some non-limiting embodiments or aspects related to the gameplay system, ingestion includes retrieving asset identifiers for properties included in an upcoming contest round, ensuring contest-relevant attributes are current. The market boss® game engine 140 may request updated embeddings, pricing trends, or model explanations for assets selected for gameplay. When contest-relevant attributes change, the event-driven feedback module 150 may notify both the valuation engine 120 and the game engine 140, ensuring that predicted sale outcomes, bid scoring rules, and leaderboard metrics reflect the most current data.

In some non-limiting embodiments or aspects, ingestion updates may increase or decrease downstream model confidence. For example, when a high-resolution interior photo replaces a low-quality image, the image-analysis module 121 may regenerate condition signals with higher certainty. Conversely, when conflicting structured inputs are present, the system may lower confidence scores or flag the asset for manual verification.

In some non-limiting embodiments or aspects, the vector-embedding database may detect drift when incoming updates cause one or more embedding vectors to deviate from prior stored versions beyond a similarity threshold. When drift exceeds the threshold, embeddings may be regenerated; when drift is below the threshold, previously stored embeddings may be reused, improving system performance.

As shown in FIG. 2, at step 204, workflow 200 includes notifying one or more downstream modules, model pipelines, or user-facing components that an event necessitating action has been detected. As an example, the event-driven feedback module 150, the central ai/valuation engine 120, the data ingestion module 110, or the dissemination and output module 160 initiate or propagate such notifications. As an example, notifications may also be transmitted to external systems (e.g., listing platforms, partner applications, contest-management servers, etc.) or to user computing devices associated with analysts, agents, or gameplay participants.

In some non-limiting embodiments or aspects, notification processing begins when the event-driven feedback module 150 receives an event object generated during step 202. The module may evaluate one or more fields of the event object, such as the type of data that changed, a magnitude score, or a set of dependent modules affected. Based on this evaluation, the module may transmit a notification to the appropriate sub-module of the central ai/valuation engine 120 (e.g., the image-analysis module 121, the location-context processor 122, or the valuation/prediction module 123), instructing it to refresh internal features, recalculate embeddings, or re-execute a pipeline stage.

In some non-limiting embodiments or aspects, notifications may include a payload identifying the changed attributes, a timestamp, and a version-id for the updated data. Downstream modules may use the version-id to determine whether their cached representations are stale. For example, if the image-analysis module 121 receives a notification indicating that newly ingested images were uploaded, the module may invalidate prior condition-signal vectors, schedule regeneration of visual features, or set a flag instructing the valuation/prediction module 123 to defer computation until updated signals are available.

In some non-limiting embodiments or aspects, when price or status changes are detected, the event-driven feedback module 150 may notify the comparable-selection logic of valuation module 123. Such notifications may include structured metadata indicating whether the change is (i) price-only, (ii) status-only, (iii) price-plus-photo, or (iv) complete listing refresh. The comparable-selection logic may adjust its candidate comp set, re-score nearby or similar properties, or recompute elasticity projections used downstream.

In some non-limiting embodiments or aspects, notifications relating to contextual changes (e.g., updated school zones, zoning overlays, environmental disclosures, or neighborhood boundaries, etc.) may be routed to the location-context processor 122. Upon receiving this notification, the processor may regenerate contextual embeddings, recompute micro-neighborhood similarity features, or update hazard score tiers. After updating these values, the processor may notify the valuation/prediction module 123 that contextual features have changed and trigger selective recomputation of dependent valuations.

In some non-limiting embodiments or aspects, notifications may propagate outward to user-facing components. For example, when a valuation meaningfully changes, the dissemination and output module 160 may generate automated alerts for users (e.g., “valuation updated,” “dom prediction changed,” “new comp selected,” etc.). These alerts may be transmitted to a mobile application, a web dashboard, or contest participants. In some non-limiting embodiments or aspects, the notification may include a summary or delta explanation illustrating which model drivers changed.

In some non-limiting embodiments or aspects, the market boss® game engine 140 may be notified when an asset selected for gameplay undergoes a material update. For example, if a verified sale price is ingested, the game engine may close a contest round, compute scoring outcomes, or update leaderboard rankings. If a new listing photo arrives mid-round, the game engine may adjust the available valuation features, lock the attribute set for fairness, or trigger recalculation of expected-value baselines used for prediction-accuracy metrics.

In some non-limiting embodiments or aspects, notification delivery may be conditional on an impact score that reflects how substantially the change affects valuations or gameplay outcomes. For example, minor formatting changes or metadata corrections may not propagate downstream, whereas structural changes (e.g., square-footage corrections, photo replacements, comp sales, etc.) may produce high-impact notifications that cascade across multiple modules.

In some non-limiting embodiments or aspects, notifications may generate chained updates. For example, updating condition signals may trigger updated comp selection, which may trigger updated price-per-square-foot normalization, which may trigger revised valuation and dom predictions. Each chained update may generate its own notification object, enabling precise tracking of how each model state evolves.

In some non-limiting embodiments or aspects, the system may maintain a real-time notification log that records each event, each target module notified, and each downstream action taken. This log may improve transparency, aid auditability, and support debugging of valuation outputs or gameplay scoring.

In some non-limiting embodiments or aspects, upon identifying an event, the event-driven orchestration layer automatically notifies one or more dependent valuation and prediction pipelines. For example, a new set of property photos may trigger the photo-analysis engine to recompute room classifications or condition scores, which in turn may trigger re-evaluation of comp-tier selection or dom prediction curves. As an example, user computing devices may receive updated valuation notices, gameplay participants may receive alerts that a target property has undergone a market-changing update, and the explainability engine may be notified that an existing reasoning object has become stale and requires regeneration to maintain determinism and consistency.

In some non-limiting embodiments or aspects, the system governs not only the computational outputs of workflow 200 but also the internal states of each module and the rules by which those states transition. The system does not merely generate valuations or predictions; instead, it maintains a structured state model that defines (i) the state of multimodal inputs, (ii) the state of intermediate feature representations, (iii) the state of comparable-selection outputs, (iv) the state of reasoning objects, and (v) the state of gameplay outcomes.

In some non-limiting embodiments or aspects, each state is associated with governance rules specifying how the system enters that state, how the state is classified, how the state maps to downstream states, and how synchronization is maintained across modules such as central ai/valuation engine 120, event-driven feedback module 150, vector-embedding architecture, and dissemination and output module 160.

In some non-limiting embodiments or aspects, the system applies explicit transition rules that determine when a module must invalidate a prior state, regenerate a partial state, or map a state to a downstream representation. For example, an updated image state may trigger a transition from “stale-embedding state” to “regeneration-required state,” which the orchestration layer interprets as a dependency that forces recomputation of condition signals, comp tiers, DOM predictions, and elasticity surfaces.

In some non-limiting embodiments or aspects, each state transition is recorded with an associated version identifier, state-classification label, upstream dependency list, and downstream propagation scope. This enables deterministic replayability, ensures that all modules across workflow 200 remain synchronized, and prevents divergence between intermediate signals—such as image embeddings, contextual embeddings, comp-selection weights, reasoning objects, and gameplay scoring variables.

In some non-limiting embodiments or aspects, the system enforces state-governance contracts that ensure consistency across distributed or asynchronous computations. For example, a valuation state is not considered valid unless the system verifies that (i) its underlying embeddings correspond to the most recent ingestion state, (ii) comparable-selection outputs correspond to the correct neighborhood-context state, and (iii) the reasoning object reflects the correct valuation-state version. Only after satisfying these governance rules may dissemination and output module 160 publish the valuation package or may market boss® game engine 140 finalize gameplay scoring.

In some non-limiting embodiments or aspects, state-governance rules also define how internal states map to gameplay mechanics. For example, when a verified sale price is ingested, the system transitions the property's gameplay state from “pending-outcome” to “final-outcome,” enabling deterministic scoring and leaderboard recalculation. Likewise, when a valuation update occurs mid-round, the system may transition from a “mutable-feature state” to a “locked-feature state” to ensure fairness across all participants.

In some non-limiting embodiments or aspects, the system may maintain a global state-synchronization model ensuring that all dependent modules—such as the CMA engine, DOM engine, list-price optimization engine, explainability engine, gameplay engine, and prize engine—operate on a coherent and contemporaneous set of signals. This prevents drift, inconsistencies, and race conditions when multiple updates occur in rapid succession across large datasets.

In some non-limiting embodiments or aspects, the state-governance framework described herein may be used to coordinate how each module interprets upstream changes, transitions between intermediate processing stages, and validates corresponding downstream outputs. By enforcing explicit state transitions and synchronization rules, the system improves technical operation by preventing stale data propagation, ensuring deterministic recomputation, reducing unnecessary pipeline execution, and maintaining consistent reasoning outputs across distributed components.

In some non-limiting embodiments or aspects, the state-governance model further improves computational efficiency by enabling selective re-execution of only those sub-modules whose dependent states have changed, thereby reducing compute cost, improving latency, and avoiding redundant model invocations. The approach enhances system reliability by ensuring all valuation, explainability, DOM, elasticity, and gameplay modules operate on coherent and correctly versioned states, preventing divergence, drift, or inconsistent outputs.

In some non-limiting embodiments or aspects, applying state-governance rules improves system transparency and auditability by providing traceable state histories, version identifiers, and reproducible model outputs. These enhancements enable deterministic replay, facilitate compliance workflows, and support debugging or diagnostic activities across large-scale valuation and gameplay systems.

In some examples, the system governs not only the computational outputs of workflow 200 but also the internal states of each module and the rules by which those states transition. The system does not merely generate valuations or predictions; instead, it maintains a structured state model that defines (i) the state of multimodal inputs, (e.g., images, structured attributes, contextual features), (ii) the state of intermediate feature representations, (iii) the state of comparable-selection outputs, (iv) the state of reasoning objects generated by the explainability engine, and (v) the state of gameplay outcomes within market boss® game engine 140.

In some examples, the state-governance framework described herein coordinates how each module interprets upstream changes, transitions between intermediate processing stages, and validates corresponding downstream outputs. By enforcing explicit state transitions and synchronization rules, the system improves technical operation by preventing stale data propagation, ensuring deterministic recomputation, reducing unnecessary pipeline execution, and maintaining consistent reasoning outputs across distributed components.

In some examples, the state-governance model improves computational efficiency by enabling selective re-execution of only those sub-modules whose dependent states have changed, thereby reducing compute cycles, improving latency, and avoiding redundant model invocations. The approach enhances system reliability by ensuring that all valuation, explainability, DOM, elasticity, and gameplay modules operate on coherent and correctly versioned states, preventing divergence, drift, or inconsistent outputs.

In some examples, applying state-governance rules improves transparency and auditability by providing traceable state histories, version identifiers, and reproducible model outputs. These enhancements enable deterministic replay, support compliance and audit workflows, and facilitate debugging or diagnostic activities across large-scale valuation and gameplay infrastructures.

In some non-limiting embodiments or aspects, each state is associated with governance rules specifying how the system enters that state, how the state is classified, how the state maps to downstream states, and how synchronization is maintained across modules such as central ai/valuation engine 120, event-driven feedback module 150, vector-embedding architecture, dissemination and output module 160, and gameplay engine 140.

In some non-limiting embodiments or aspects, the system applies explicit transition rules that determine when a module must invalidate a prior state, regenerate a partial state, or map a state to a downstream representation. For example, an updated image state may trigger a transition from a stale-embedding state to a regeneration-required state, which orchestration layer 150 interprets as necessitating recomputation of condition features, comparable-selection tiers, DOM predictions, and price-time elasticity surfaces.

In some non-limiting embodiments or aspects, each state transition is recorded with an associated version identifier, state-classification label, upstream dependency list, and downstream propagation scope. This enables deterministic replayability, ensures synchronization of intermediate signals such as image embeddings, contextual embeddings, comp-selection weights, reasoning objects, and gameplay scoring variables, and prevents divergence between distributed modules.

In some non-limiting embodiments or aspects, the system enforces state-governance contracts that ensure consistency across asynchronous or distributed computations. For example, a valuation state is not considered valid unless the system verifies that (i) its underlying embeddings correspond to the most recent ingestion state, (ii) comparable-selection outputs correspond to the correct contextual state, and (iii) the reasoning object reflects the correct valuation-state version. Only after satisfying these governance rules may dissemination and output module 160 publish the valuation package or may market boss® game engine 140 finalize gameplay scoring.

In some non-limiting embodiments or aspects, state-governance rules also define how internal states map to gameplay mechanics. For example, when a verified sale price is ingested, the system transitions the property's gameplay state from a pending-outcome state to a final-outcome state, enabling deterministic scoring and leaderboard recalculation. Similarly, when a valuation update occurs mid-round, the system may transition from a mutable-feature state to a locked-feature state to ensure fairness among all participants.

In some non-limiting embodiments or aspects, the system may maintain a global state-synchronization model ensuring that dependent modules (e.g., such as the cma engine, the dom engine, the list-price optimization engine, the explainability engine, the gameplay engine, the prize engine, etc.) operate based on coherent and contemporaneous signals. This prevents drift, race conditions, and inconsistencies when multiple updates occur in rapid succession across large datasets.

As shown in FIG. 2, at step 206, workflow 200 includes executing a multi-stage valuation pipeline to generate price estimates, market-time predictions, and elasticity surfaces. In some non-limiting embodiments or aspects, the multi-stage valuation pipeline is performed by one or more components of system architecture 100 including the central ai/valuation engine 120, image-analysis module 121, comparable-selection module 122, valuation/prediction module 123, event-driven orchestration layer 150, and the vector-embedding database.

In some non-limiting embodiments or aspects, execution of step 206 is triggered when step 202 or step 204 identifies that input features, embeddings, or contextual attributes have changed more than a configured delta. The event-driven orchestration layer 150 may determine which stages of the pipeline must be recomputed, and whether upstream feature vectors can be reused from the vector-embedding database based on embedding-reuse criteria (e.g., similarity drift thresholds, timestamp thresholds, version-skew scores).

In some examples, the image-analysis module 121 receives one or more images to generate condition indicators, room classifications, visual-appeal signals, and raw or transformed image embeddings. When new images or updated embeddings are detected, the image-analysis module 121 may invalidate cached condition signals, regenerate missing feature vectors, or publish updated visual features to the valuation/prediction module 123.

In some non-limiting embodiments or aspects, the comparable-selection module 122 retrieves candidate comparable assets from the vector-embedding database. Comparable-selection may include computing nearest-neighbor distances, applying similarity thresholds, weighting results by geographic proximity, or filtering out assets with attribute mismatches. When embedding deltas exceed a configured limit, the module may recompute similarity rankings, update tier assignments, or refresh the comp bundle used for downstream adjustments.

In some non-limiting embodiments or aspects, the valuation/prediction module 123 generates estimated market value, days-on-market (DOM) predictions, and price-time elasticity surfaces. The module may evaluate pricing scenarios across multiple hypothetical list prices, compute DOM curves, model buyer-response sensitivity, or generate uncertainty intervals. When comp selection, condition signals, or contextual features change, the valuation/prediction module 123 may partially or fully recompute these outputs, depending on dependency graphs stored within the orchestration layer.

In some non-limiting embodiments or aspects, workflow-orchestration logic determines whether downstream stages must be recomputed based on input deltas, prediction confidence thresholds, or dependency-resolution rules. For example, if only contextual features changed (e.g., updated school-zone assignment), the system may recompute comp similarity scores but reuse image-derived features. If both image signals and comp tiers changed, a complete recomputation of DOM curves and elasticity surfaces may be scheduled.

In some non-limiting embodiments or aspects related to gameplay, the market boss® game engine 140 receives updated valuation outputs to define contest pricing bands, scoring tolerance windows, or expected-value baselines for prediction game rounds. When valuations or DOM predictions change materially, the game engine may regenerate contest parameters, freeze new attribute inputs for fairness, or notify participants of potential shifts in value dynamics.

In some non-limiting embodiments or aspects, the dissemination and output module 160 monitors the completion of step 206 and may prepare updated valuations, DOM curves, or elasticity surfaces for delivery to user interfaces. When the restructuring of model outputs creates a substantial difference from prior valuations, the dissemination module may also generate deltas, highlight key drivers that changed, or schedule regeneration of explainability outputs.

As shown in FIG. 2, at step 208, workflow 200 includes determining or generating one or more call-to-action outputs based on predicted valuation outcomes, market-state dynamics, or gameplay mechanics. In some non-limiting embodiments or aspects, one or more of these call-to-action determinations are performed by the list-price optimization engine, the dom engine, the explainability engine, the gameplay engine, or one or more user interfaces depicted in system architecture 100 of FIG. 1.

In some non-limiting embodiments or aspects, the explainability engine (e.g., explainability module 123 of FIG. 1) generates a structured reasoning object containing explanation fields associated with comparable selection, valuation adjustments, dom drivers, confidence metrics, or price-elasticity factors derived from earlier stages of workflow 200. The structured reasoning object may consolidate heterogeneous model outputs—such as comp-tier alignment, contextual embedding influences, or condition-signal weights—into a unified explanatory representation.

In some non-limiting embodiments or aspects, the structured reasoning object is validated against a deterministic reasoning schema to ensure consistency, completeness, logical coherence, and adherence to template constraints. The validation process may include verifying required fields, checking the ordering of explanation components, ensuring that numerical values fall within bounded tolerances, or confirming that causal narratives match upstream model decisions.

In some non-limiting embodiments or aspects, if the structured reasoning object fails validation, the system may trigger re-evaluation of one or more upstream signals or may generate fallback templates to prevent inconsistent reporting. The fallback process may include regenerating comp-adjustment narratives, recalculating confidence metrics, or recomputing dom-driver explanations until the reasoning object conforms to the schema.

In some non-limiting embodiments or aspects, validated reasoning objects may be used to generate narrative explanations (e.g., agent-facing pricing summaries), graphical valuation overlays (e.g., showing valuation deltas or dominant model drivers), or avatar-based video scripts communicated by the dissemination and output module 160. In other embodiments, explainability outputs may be cached, versioned, or linked to specific valuation snapshots for audit purposes.

In some non-limiting embodiments or aspects supporting gameplay, explanatory text derived from the reasoning object may be surfaced to contestants as hints, training modules, professional-mode insights, or tiered-access content. For example, the gameplay engine 140 may selectively reveal reasoning fields depending on gameplay mode, user expertise level, or contest rules.

In some non-limiting embodiments or aspects, the list-price optimization engine analyzes price-time elasticity curves, seller-goal weights, and updated market-velocity inputs to produce pricing recommendations or strategic guidance. The call-to-action may include one or more of: recommended list-price adjustments, confidence intervals describing valuation uncertainty, timing-based pricing strategies, or positioning guidance relative to competitive listings in the embedding space.

In some non-limiting embodiments or aspects, the dom engine contributes to call-to-action determinations by analyzing survival curves, hazard-rate distributions, or historical absorption patterns. For example, the dom engine may generate a call-to-action recommending a more aggressive price if the dom curves indicate low demand elasticity, or a higher price if hazard rates flatten at upper price ranges.

In some non-limiting embodiments or aspects, the gameplay engine determines gameplay-specific call-to-action outputs. These may include whether a player should bid, pass, trade up, downsize, or exercise an allowance-based mechanic. The gameplay engine may compute expected-value signals, confidence thresholds, or game-balance conditions that define recommended actions in a contest round.

In some non-limiting embodiments or aspects, the user interface may surface call-to-action outputs through interactive dashboards, mobile notifications, or immersive formats (e.g., avatar guidance). The output may include a delta summary comparing prior valuations to updated valuations, or an action-rationale script generated by the explainability engine.

In some non-limiting embodiments or aspects, the event-driven orchestration layer may trigger step 208 when upstream changes exceed predefined impact thresholds. For example, a significant comp-sale update may trigger call-to-action regeneration; minor metadata edits may not. The orchestration layer may propagate call-to-action outputs to dependent modules or user-facing systems.

As shown in FIG. 2, at step 208, workflow 200 includes determining or generating one or more call-to-action outputs based on predicted valuation outcomes, market-state dynamics, or gameplay mechanics. In some non-limiting embodiments or aspects, one or more of these call-to-action determinations are performed by list-price optimization logic within valuation/prediction module 123, the dom engine within valuation/prediction module 123, the explainability engine included within central ai/valuation engine 120, the market boss® game engine 140, or one or more user interfaces provided by dissemination and output module 160.

In some non-limiting embodiments or aspects, explainability module 123 generates a structured reasoning object containing explanation fields associated with comparable selection, valuation adjustments, dom drivers, confidence metrics, or price-elasticity factors derived from prior stages of workflow 200. The structured reasoning object may consolidate heterogeneous signals—including outputs from image-analysis module 121, contextual features from location-context processor 122, embeddings from vector-embedding structures, or comp-selection logic executed by module 123.

In some non-limiting embodiments or aspects, the structured reasoning object is validated against a deterministic reasoning schema maintained by explainability engine 123 to ensure completeness, ordering correctness, coherence with upstream model decisions, and stability across repeated executions. Validation may include checking required fields, verifying numerical tolerances, confirming attribution causality, or detecting missing comp-driver segments.

In some non-limiting embodiments or aspects, a failed reasoning-object validation may trigger recomputation of upstream features (e.g., updated condition signals from module 121, refreshed contextual embeddings from module 122) or may invoke fallback narrative templates stored within explainability engine 123 to ensure deterministic and interpretable reporting in all cases.

In some non-limiting embodiments or aspects, validated reasoning objects may be transmitted to dissemination and output module 160 to generate textual narratives, graphical overlays, valuation-delta charts, or avatar-based video scripts. In some embodiments, reasoning objects may also be cached, versioned, or linked to valuation snapshots for auditability and reproducibility.

In some non-limiting embodiments or aspects supporting gameplay, market boss® game engine 140 may receive portions of the reasoning object, enabling contestants to view hints, structured insights, or professional-mode explanations. Gameplay engine 140 may restrict or expand which explanatory fields are visible based on gameplay rules, tiers, contest format, or fairness requirements.

In some non-limiting embodiments or aspects, valuation/prediction module 123 determines pricing-related call-to-action recommendations by analyzing price-time elasticity curves, seller-goal weights, and dynamic market-velocity indicators. The resulting call-to-action may include recommended listing-price adjustments, valuation-confidence intervals, or strategic pricing bands relative to comp-tier distributions.

In some non-limiting embodiments or aspects, the dom engine within module 123 contributes call-to-action outputs by analyzing survival-curve estimates, hazard-rate behavior, or absorption-pattern shifts. For example, dom outputs may lead to a recommendation to raise or lower price depending on predicted market friction at specific price points.

In some non-limiting embodiments or aspects, gameplay engine 140 determines contest-related call-to-action guidance. Such guidance may include instructions for players to bid, pass, trade up, allocate allowance resources, or time their predictions based on model-derived expected-value metrics or accuracy-trend indicators.

In some non-limiting embodiments or aspects, dissemination and output module 160 surfaces call-to-action outputs to end-users via dashboards, mobile alerts, push notifications, or avatar-delivered explanations. The output layer may include delta summaries highlighting changes in valuation, dom, or comp selection, anchored by reasoning fields generated by explainability engine 123.

In some non-limiting embodiments or aspects, event-driven feedback module 150 may trigger execution of step 208 when upstream changes (e.g., new images, comp-sales updates, contextual-zone modifications) exceed predefined impact thresholds. Module 150 may also propagate updated call-to-action outputs to downstream systems, user devices, or the gameplay environment.

As shown in FIG. 2, at step 210, workflow 200 includes monitoring execution, model-pipeline progress, valuation stability, DOM-curve completion, gameplay outcomes, and user or market feedback. In some non-limiting embodiments or aspects, one or more of these monitoring operations are performed by event-driven feedback module 150, dissemination and output module 160, central ai/valuation engine 120, vector-embedding architecture associated with modules 121-123, or market boss® game engine 140.

In some non-limiting embodiments or aspects, event-driven feedback module 150 continuously monitors one or more upstream event sources including external listing feeds, internal ingestion logs of data ingestion module 110, public-record updates, sale-record changes, price adjustments, posting of new competitive listings, and uploading of new media assets. The module may poll, subscribe to, or receive push-based events depending on the source.

In some non-limiting embodiments or aspects, module 150 classifies each detected update into an event type (e.g., “status change,” “price drop,” “condition-signal update,” “competitive listing added,” “new media available,” “comp-sale refresh”). Event objects may include timestamps, data-delta magnitudes, upstream-module identifiers, and one or more predicted impact scores.

In some non-limiting embodiments or aspects, event-driven feedback module 150 computes dependency chains that identify which nodes of the valuation pipeline depend upon the changed inputs. For example, a new exterior photo may affect the image-analysis module 121, which affects location-context processor 122 only indirectly, but may directly impact valuation/prediction module 123 via updated condition scores. A competitive-listing event may bypass module 121 entirely but directly impact comparable-selection logic within module 123. The dependency chain may be stored as a directed acyclic graph maintained by module 150.

In some non-limiting embodiments or aspects, module 150 monitors staleness conditions by comparing version-ids of embeddings stored in the vector-database with current inputs. When embedding age, version drift, or similarity deviation exceeds a configured threshold, module 150 may flag the corresponding embedding as stale and schedule regeneration in module 121, 122, or 123.

In some non-limiting embodiments or aspects, module 150 monitors valuation stability by comparing successive valuation outputs from module 123, tracking valuation deltas, reporting volatility, and determining whether output changes exceed a configured tolerance. This enables selective recomputation and prevents cascading recalculation when changes are immaterial.

In some non-limiting embodiments or aspects, module 150 monitors DOM-curve completion by evaluating whether survival-analysis estimators or hazard-model computations within module 123 completed successfully, encountered missing features, or require recalculation due to upstream updates. Module 150 may track confidence intervals or error bounds associated with DOM projections.

In some non-limiting embodiments or aspects, dissemination and output module 160 provides real-time monitoring dashboards, logs, alerts, or graphical overlays visualizing how recent updates propagate through the valuation pipeline. Dashboards may depict comp movements, embedding-space drift, DOM-curve shifts, condition-signal replacements, or recalculated elasticity surfaces.

In some non-limiting embodiments or aspects, market boss® game engine 140 monitors gameplay-relevant events such as finalized sale records, listing expiration, price drops, or new-photo events that may impact fairness or timing of contest rounds. Module 140 may monitor property outcomes until actual sale results are verified, after which gameplay scoring may be computed, leaderboards updated, or outcome-based awards released.

In some non-limiting embodiments or aspects, module 150 detects anomalies or drift within image, text, or contextual embeddings. When anomaly scores exceed thresholds, module 150 may trigger recalculation, escalate alerts to module 160, or mark the affected asset for manual inspection.

In another example, module 150 monitors pipeline execution status by tracking the progress of each model node (e.g., “pending,” “running,” “completed,” “failed,” “retry scheduled”). Failures may trigger fallback pathways (e.g., reuse of prior embeddings, cached valuations, or simplified comp-selection heuristics).

In another example, module 150 synchronizes monitoring outputs with user interfaces of module 160, enabling agents, analysts, or gameplay participants to review market-shifting events, valuation-impact assessments, or pending recompilation and/or recompute tasks.

In another example, monitoring may include scoring of model performance over time, comparisons against market outcomes, real-estate seasonality indicators, or behavioral-signal feedback loops derived from gameplay accuracy histories. These monitoring signals may be fed back into one or more machine-learning models for retraining or calibration.

As shown in FIG. 2, at step 212, workflow 200 includes predicting valuation outputs, DOM distributions, price-time elasticity, reasoning-object updates, and gameplay outcomes using historical data, embeddings, and market-state parameters. In another example, one or more of these predictive operations or recomputation actions are performed by central ai/valuation engine 120, including image-analysis module 121, comparable-selection and context-processing module 122, valuation/prediction module 123, market boss® game engine 140, the vector-embedding architecture, and the event-driven orchestration layer 150. The function of step 212 is to selectively re-execute one or more stages of the valuation pipeline based on dependency analysis, update-event type, or embedding-reuse criteria, thereby producing updated valuations, DOM curves, elasticity surfaces, and gameplay scoring outcomes.

In another example, event-driven feedback module 150 determines which pipeline stages must be recomputed by evaluating a dependency chain constructed during step 210. The dependency chain may define the directional relationships among upstream and downstream modules (e.g., image features→comp selection→valuation →DOM→elasticity→gameplay scoring) and may specify which nodes require refresh when data changes occur.

In some non-limiting embodiments or aspects, when new listing images or revised media assets are detected, image-analysis module 121 regenerates image embeddings, condition indicators, visual-appeal signals, and room-classification metadata. After regeneration, module 121 transmits updated feature vectors to module 122, indicating that downstream stages require partial or full recomputation.

In some non-limiting embodiments or aspects, when only comparable-market activity changes—such as a nearby sale, a newly listed competitive property, or a pricing update—module 122 may re-execute comparable-selection logic without recomputing visual embeddings. Module 122 may re-score candidate comparables, apply similarity thresholds, recompute normalization coefficients, or update weighting heuristics while reusing embeddings previously stored in the vector-embedding database.

In some examples, embedding reuse occurs when similarity drift, embedding age, or version-distance metrics remain below a configured threshold. When reuse criteria are satisfied, the system bypasses computationally expensive embedding regeneration and instead retrieves existing vectors from the vector-embedding database, improving system responsiveness and reducing compute load.

In some non-limiting embodiments or aspects, valuation/prediction module 123 recalculates updated valuation estimates, revised DOM projections, refreshed elasticity surfaces, or updated hazard-model outputs. Recalculation may incorporate newly selected comparables, revised contextual signals, updated behavioral metrics, or drift-corrected embeddings.

In some examples, recomputation yields updated confidence intervals, delta magnitudes, and stability indicators. These values may be stored in an internal audit log or forwarded to dissemination and output module 160 for user-facing presentation.

In some examples supporting gameplay, market boss® game engine 140 may re-evaluate in-round game conditions. For example, if a verified sale price is ingested, the game engine may finalize contest results, evaluate player-submitted bids against actual outcomes, update player balances or allowances, or determine whether any user achieved a perfect-prediction bonus.

In some examples, gameplay recomputation may adjust expected-value ranges, acquisition outcomes, or score multipliers for properties still in contest rounds. Updated results may be delivered to user interfaces through module 160.

In some examples, selective recomputation may generate chained updates—for example, updated condition signals may propagate to comp reselection, which then triggers valuation recomputation, which then triggers DOM-curve refresh, which then triggers an updated price-time elasticity surface. Each substage may emit its own notification enabling downstream tracking and deterministic replayability.

In some non-limiting embodiments or aspects, recomputation may consider competitive-listing movement, market-velocity changes, or micro-neighborhood pricing drift. These dynamics may cause selective recalculation of only those elasticity curves whose underlying feature sets changed.

In some non-limiting embodiments or aspects, updated predictions may be used both for valuation and gameplay purposes. For example, newly calculated elasticity surfaces may adjust educational hints, training scripts, or narrative modules surfaced to game participants or professional-mode users.

In some non-limiting embodiments or aspects, central ai/valuation engine 120 coordinates selective recomputation of one or more valuation outputs. For example, engine 120 may determine which valuation sub-modules must be refreshed based on the type of update event detected at step 210 (e.g., new images, price changes, newly available sales data, comp-market drift). Engine 120 may further allocate computational resources, schedule pipeline execution, and maintain determinism by tracking version identifiers for embeddings, context signals, and comp-selection inputs.

In some examples, the cma engine within module 122 executes comparable-selection logic using updated embeddings, contextual features, or comp-activity records. The cma engine may retrieve nearest-neighbor embeddings from the vector-embedding database, apply similarity thresholds, re-score comp candidates, or recompute adjustment coefficients. When upstream signals change (e.g., revised condition features, updated neighborhood identifiers), the cma engine may selectively recompute comp tiers without re-running upstream image pipelines.

In some examples, the dom engine within module 123 recalculates updated days-on-market (DOM) trajectories. For example, the dom engine may recompute hazard curves, refresh survival-analysis outputs, or generate multi-price DOM projections using updated comparables, revised pricing history, or new competitive-listing behavior. The dom engine may also determine whether DOM recalculation is necessary by evaluating confidence bounds, feature drift, or model-accuracy thresholds.

In some examples, the list-price optimization engine within module 123 computes updated price-time elasticity surfaces and recommended listing-price bands. For example, the optimization engine may recompute elasticity grids when valuation estimates change, when DOM projections shift due to new competitive activity, or when behavioral-signal drift indicates a change in expected buyer sensitivity. The optimization engine may further determine whether price-curve recomputation can reuse previously stored elasticity parameters or whether recalculation is required.

In some examples, the vector-embedding database provides reusable similarity representations that accelerate selective recomputation. The database may store historical embeddings, maintain version histories, detect embedding drift, or determine whether embedding reuse criteria are met for the current recomputation cycle. When embeddings remain within a configured drift tolerance, the database may supply stored vectors, bypassing upstream regeneration; when drift exceeds thresholds, the system may invalidate older embeddings and trigger upstream modules to regenerate them.

In some examples, the event-driven orchestration layer 150 determines the recomputation scope for step 212. For example, the orchestration layer may identify which pipeline nodes depend on the updated data, construct a dependency graph indicating required recomputation order, or dispatch recomputation events to the relevant modules of engine 120. The orchestration layer may also provide audit logs, produce replayable recomputation sequences, or generate impact scores determining whether recomputation should propagate to user-facing components or gameplay systems.

As shown in FIG. 2, at step 214, workflow 200 includes outputting updated valuation results, explanations, and optional gameplay outcomes to one or more user interfaces, external systems, or downstream modules. In some non-limiting embodiments or aspects, one or more of these output operations are performed by dissemination and output module 160, central ai/valuation engine 120, explainability engine, avatar-generation module, video-synthesis interface, market boss® game engine 140, or a prize engine.

In some non-limiting embodiments or aspects, one or more of these output operations are performed in step 214 to deliver an updated valuation package, including a valuation, DOM predictions, price-time elasticity surfaces, and one or more validated reasoning objects, to presentation layers or interactive systems while ensuring consistency, determinism, and version traceability across all downstream outputs.

In some non-limiting embodiments or aspects, dissemination and output module 160 generates an updated explainable valuation package comprising the revised valuation estimate, updated DOM curve, refreshed elasticity surface, and a validated reasoning object produced by the explainability engine. The valuation package may further include confidence intervals, delta indicators, stability metrics, or feature-level contributions.

In some non-limiting embodiments or aspects, the valuation package may be serialized as structured JSON, bindable UI components, narrative text, tabular summaries, or audiovisual content synchronized through an avatar-based delivery mode. For example, the avatar-generation module may convert the reasoning object into script segments, which the video-synthesis interface may render as an animated avatar explanation for users, analysts, or gameplay participants.

In some non-limiting embodiments or aspects, the explainability engine may produce multiple explanation tiers—including concise summaries, professional-mode deep dives, comp-rationale heatmaps, or DOM-driver narratives—each routed to different user roles or access levels. The engine may further apply deterministic schema validation to ensure internal logical consistency before any explanation is surfaced externally.

In some examples, updated valuation outputs or real-time market events may be delivered to user interfaces such as mobile apps, web dashboards, professional analytics consoles, or contest portals. Notifications may include indicators such as “valuation updated,” “new comp selected,” “dom curve refreshed,” or “game results finalized.”

In some non-limiting embodiments or aspects, market boss® game engine 140 consumes updated sale outcomes or new valuation cycles to score user predictions. The game engine may determine whether a user's predicted sale price falls within a tolerance band, exceeds an over-prediction threshold, or matches the verified sale price closely enough to qualify for a perfect-prediction bonus. Based on these determinations, the game engine may adjust contest balances, apply deduction rules, issue property acquisitions, trigger trade-up mechanics, or lock contest rounds when a verified sale price becomes available.

In some non-limiting embodiments or aspects, scoring results may be used to update real-time leaderboards, compute accuracy streaks, adjust ranking tiers, or trigger prize-eligibility conditions. In some examples, a prize engine may allocate rewards (e.g., digital goods, educational modules, access to premium features, or cash-equivalent credits) based on scoring outcomes, accuracy history, or threshold-based achievement rules.

In some non-limiting embodiments or aspects, aggregated behavioral signals from gameplay (e.g., user accuracy histories, bid-bias patterns, confidence-interval tendencies, valuation-challenge selections, or prediction-time distributions) may be fed back into event-driven feedback module 150 or central ai/valuation engine 120. These behavioral features may improve comp-selection logic, refine elasticity modeling, or recalibrate next-round contest difficulty.

In some non-limiting embodiments or aspects, resolution activities may include synthesizing final deterministic reasoning objects, generating updated narrative content, or delivering avatar-rendered explanations to end users. In gameplay contexts, resolution may further include finalizing contest results, resolving tie-conditions, assigning bonuses for perfect predictions, or awarding prizes based on user performance.

In some non-limiting embodiments or aspects, the system may store timestamps, version identifiers, lineage metadata, or computational signatures for each reasoning object, embedding vector, valuation output, or gameplay decision. These identifiers enable reproducibility, auditability, backward traceability, and deterministic reconstruction of the valuation state at any prior moment.

As an example, the system may also maintain a historical output registry that records all valuation changes, explanation updates, comp transitions, or gameplay scoring changes. This registry may be used for compliance, debugging, fairness verification, leaderboard reconstruction, or longitudinal model-quality analytics.

In some examples, the system governs not only the computational outputs of workflow 200 but also the internal states of each module and the rules by which those states transition. The system maintains a structured state model that defines (i) the state of multimodal inputs (e.g., images, structured attributes, contextual features), (ii) the state of intermediate feature representations, (iii) the state of comparable-selection outputs, (iv) the state of reasoning objects generated by the explainability engine, and (v) the state of gameplay outcomes within market boss® game engine 140.

In some non-limiting embodiments or aspects, each state is associated with governance rules specifying how the system enters that state, how the state is classified, how the state maps to downstream states, and how synchronization is maintained across modules such as central AI/valuation engine 120, event-driven feedback module 150, the vector-embedding architecture, dissemination and output module 160, and gameplay engine 140. These governance rules coordinate how each module interprets upstream changes, transitions between intermediate processing stages, and validates corresponding downstream outputs.

In some non-limiting embodiments or aspects, the system applies explicit transition rules that determine when a module must invalidate a prior state, regenerate a partial state, or map a state to a downstream representation. For example, an updated image state may trigger a transition from a stale-embedding state to a regeneration-required state, which orchestration layer 150 interprets as requiring recomputation of condition features, comparable-selection tiers, DOM predictions, and price-time elasticity surfaces.

In some non-limiting embodiments or aspects, each state transition is recorded with a version identifier, a state-classification label, an upstream dependency list, and a downstream propagation scope. This improves determinism, enables replayability, and prevents divergence across intermediate signals such as image embeddings, contextual embeddings, comp-selection weights, reasoning objects, and gameplay scoring variables.

In some non-limiting embodiments or aspects, the system enforces state-governance contracts that ensure internal consistency across asynchronous or distributed computations. A valuation state, for example, is not considered valid unless (i) its underlying embeddings correspond to the most recent ingestion state, (ii) comparable-selection outputs correspond to the correct contextual state, and (iii) the reasoning object reflects the matching valuation-state version. Only after satisfying these governance rules may dissemination and output module 160 publish a valuation package or may market boss® game engine 140 finalize gameplay scoring.

In some non-limiting embodiments or aspects, state-governance rules also define how internal states map to gameplay mechanics. When a verified sale price is ingested, the system transitions a property's gameplay state from a pending-outcome state to a final-outcome state, enabling deterministic scoring and leaderboard recalculation. When a valuation update occurs mid-round, the system may transition from a mutable-feature state to a locked-feature state to ensure fairness among all participants.

In some non-limiting embodiments or aspects, the system may maintain a global state-synchronization model ensuring that dependent modules—including the CMA engine, DOM engine, list-price optimization engine, explainability engine, gameplay engine, and prize engine—operate only on coherent and contemporaneous signals. This prevents drift, race conditions, or inconsistent outputs when multiple update events occur in rapid succession.

In some examples, the state-governance framework improves technical operation by preventing stale-data propagation, ensuring deterministic recomputation, reducing unnecessary pipeline execution, and maintaining consistent reasoning outputs across distributed components. The model further improves computational efficiency by enabling selective re-execution of only those sub-modules whose dependent states have changed, thereby reducing compute cost, improving latency, and avoiding redundant model invocations.

In some non-limiting embodiments or aspects, applying state-governance rules enhances system transparency, auditability, and reproducibility by providing traceable state histories, version identifiers, and deterministic outputs. These capabilities support compliance workflows, diagnostic analysis, and debugging across large-scale valuation and gameplay infrastructures.

In some non-limiting embodiments or aspects, the system executes the valuation pipeline using a graph-based orchestration model in which each node represents a distinct computational module and each edge represents a dependency relationship among intermediate feature states.

In some non-limiting embodiments or aspects, the system executes the valuation pipeline using a graph-based orchestration model in which each node represents a distinct computational module and each edge represents a dependency relationship among intermediate feature states. The pipeline may be dynamically adjusted so that stages are skipped, re-ordered, or conditionally activated based on data completeness, confidence metrics, prediction-stability thresholds, latency constraints, or resource availability. Pipeline stages may operate in synchronous or asynchronous modes, and the system can employ a distributed compute topology that partitions image-processing workloads, embedding-generation workloads, and prediction workloads across multiple computing nodes, while maintaining a latency-aware execution strategy that adjusts batch size, prefetching, or caching behavior accordingly.

In some non-limiting embodiments or aspects, the system maintains a rolling cache of intermediate outputs that enables partial reuse of prior computations when upstream changes do not materially alter required features. Each valuation stage may be encapsulated as a containerized microservice, enabling independent update, rollback, replacement, or parallel execution. The system maintains version identifiers for intermediate feature states and valuation stages, allowing deterministic replay of historical valuations, and may employ a federated computation model in which certain stages execute on client devices while others execute on server infrastructure.

In some non-limiting embodiments or aspects, state-governance rules enhance transparency, auditability, and reproducibility by requiring modules to verify upstream version identifiers before accepting inputs, maintaining a dependency map identifying downstream modules to refresh when specific states change, and applying decay or expiry rules to intermediate states to prevent propagation of outdated contextual features or embeddings. The system may also maintain a global synchronization clock so that concurrently executing modules reference consistent input versions, record each state transition with a timestamp and predicate describing triggering conditions, and restrict output publication until all intermediate states satisfy validation requirements specified by a state-governance contract. These capabilities support compliance workflows, diagnostic analysis, and debugging across large-scale valuation and gameplay infrastructures.

In some non-limiting embodiments or aspects, a vector-embedding database stores image, text, contextual, temporal, and hybrid embeddings associated with assets, and computes drift scores between existing and newly generated embeddings to determine whether reuse is permissible. Embedding reuse may be conditioned on stability criteria such as gradient magnitude, density variance, distributional distance, or other similarity metrics (e.g., cosine distance, angular deviation, KL divergence), while embedding regeneration is triggered when drift exceeds thresholds indicating potential staleness for comp selection or model predictions. The database may maintain multiple historical embedding versions and contextual state identifiers to support temporal analysis, model-drift detection, and deterministic replay of valuation states.

In some non-limiting embodiments or aspects, the system caches embeddings for properties within geographic, architectural, stylistic, or behavioral clusters to accelerate similarity retrieval and may generate embeddings using multiple model families, retaining cross-model signatures for ensemble similarity retrieval. Embeddings can be compressed using quantization, pruning, dimensionality reduction, or hybrid indexing (e.g., tree-based search combined with approximate-nearest-neighbor search) to improve retrieval latency and memory usage. The system may maintain freshness scores and feature-age metadata, detect embedding staleness based on ingestion or contextual-update timestamps, and perform batch embedding regeneration for large-scale listing updates, including shard-aware retrieval and automatic reindexing when distribution drift degrades retrieval efficiency.

In some non-limiting embodiments or aspects, the system manages embedding lifecycle and governance by assigning version identifiers and lineages, computing embedding quality scores based on media resolution, attribute completeness, and contextual precision, and suppressing regeneration when low-quality inputs would degrade performance. Embeddings may be partitioned into raw, partially transformed, and fully normalized stages, and the system synchronizes embedding versions with valuation states so that structured reasoning objects reference the correct feature sets. Lifecycle rules can determine when embeddings expire, must be revalidated, archived, or regenerated, and may include cross-market and temporal embeddings that capture correlations between geographically non-adjacent but behaviorally similar markets, listing-update velocity, pricing behavior, and comp movement, as well as delta embeddings that represent incremental changes between successive inputs.

In some non-limiting embodiments or aspects, the Explainability Engine (JET) generates a structured reasoning object that consolidates heterogeneous model signals into normalized explanation fields representing valuation drivers, comp adjustments, contextual effects, DOM contributions, and price-elasticity effects. Each structured reasoning object is validated against a deterministic schema defining required fields, logical relationships, and cross-check conditions prior to user-facing publication, and may be rejected when internal consistency metrics fall below a threshold, triggering regeneration using fallback templates or secondary model paths. The reasoning engine can compress intermediate model states into human-interpretable factors while retaining machine-verifiable provenance and apply confidence-scoring logic to determine which explanation fields are promoted, suppressed, annotated, or layered.

In some non-limiting embodiments or aspects, the reasoning object includes structured metadata describing which embeddings, comparables, contextual signals, or temporal patterns contributed to each explanation field, and the system may produce multiple explanation layers, including a simplified consumer explanation, a professional-grade analytic explanation, and an audit-level technical explanation. Historical reasoning objects may be stored with version identifiers to support auditability, regulatory compliance, deterministic replay, and explanation-consistency scoring across sequential valuation events, with automatic flags for reasoning outputs that deviate from expected patterns.

In some non-limiting embodiments or aspects, the narrative-generation subsystem produces natural-language outputs using template-driven or model-driven synthesis based on the validated reasoning object. Narrative outputs may explain valuation changes, comp selection rationale, contextual effects, DOM impacts, and price-elasticity behavior, with templates dynamically selected based on property type, market conditions, or user persona. The subsystem may adjust tone, verbosity, and domain specificity for consumers, agents, analysts, or gameplay participants, generate delta-narratives highlighting which input changes triggered updates to valuation or DOM, and incorporate certainty or uncertainty metrics to qualify predicted outcomes.

In some non-limiting embodiments or aspects, the system synthesizes avatar-based video explanations by aligning voice narration, gestures, and animations with the structured reasoning object and narrative outputs. Video content may include overlays highlighting comparable properties, predicted prices, DOM curves, and price-elasticity surfaces, and can be rendered as short-form, long-form, or interactive explanations based on user preference, device type, or time constraints. Avatar-rendered outputs may be synchronized with updated reasoning objects whenever re-execution occurs due to market changes or ingestion of new data, with storyboard representations driving scene sequencing in the video-synthesis interface.

In some non-limiting embodiments or aspects, the system generates predicted days-on-market (DOM) curves using multi-parameter hazard or survival-analysis models that incorporate comparable-property turnover rates, seasonal demand cycles, pricing velocity indicators, micro-neighborhood friction coefficients, and rolling-window market snapshots. DOM predictions may be updated using event-dependent adjustments that reflect recent competitive listings, withdrawals, status transitions, or shocks (e.g., rapid contracts or price cuts) within a similarity radius, and the DOM engine may compute stability scores quantifying sensitivity to small perturbations, suppressing unstable projections until confidence thresholds are met.

In some non-limiting embodiments or aspects, the system computes a price-time elasticity surface characterizing expected market response at varying list prices, including predicted buyer-engagement intensity, offer-likelihood curves, and expected time-to-contract. Elasticity models may incorporate behavioral-response kernels derived from historical buyer activity (such as clickstream acceleration, tour-request frequency, and offer-per-exposure density), generate partial-derivative measures indicating how incremental price adjustments affect DOM, offer probability, and expected yield, and adjust elasticity surfaces when competitive listings enter or exit the market. Elasticity grids may be compressed using dimensionality-reduction techniques to support efficient rendering, versioning, and recomputation.

In some non-limiting embodiments or aspects, a competitive-listing engine computes similarity-weighted competition effects by analyzing listings with overlapping buyer segments, comparable attribute vectors, and overlapping price bands. Competitive changes may modify DOM and valuation predictions through a multi-tier influence model that differentiates strong competitors, peripheral analogs, and outlier listings, with competitive-pressure indices based on spatial clustering, similarity drift, and temporal co-listing patterns. Competitive dynamics can be incorporated into predictive outputs by reweighting comparables that enter or exit the similarity set based on embedding distance, time decay, and data-quality metrics.

In some non-limiting embodiments or aspects, the system applies temporal reasoning and state-aware forecasting by smoothing predictions across sequential valuation events to mitigate volatility when market data updates frequently, and by storing DOM and elasticity predictions with version metadata for deterministic replay and backward-consistency checks. Path-dependent forecasting may incorporate sequences of prior updates rather than relying solely on instantaneous conditions, employing decay weighting for stale comparables, amplifying recently transacted properties, and generating temporal-drift alerts when observed behavior diverges significantly from predicted DOM distributions.

In some non-limiting embodiments or aspects, DOM computations incorporate comp-tier selection structures such that higher-tier comparables shift expected exposure time and misalignment between comp tiers and subject features increases DOM uncertainty. Elasticity surfaces may be shaped by comparable-sale tempo, including absorption rates of nearest-neighbor embeddings and cycle-time patterns of attribute-similar properties. Feedback mechanisms can use updated DOM predictions to recursively adjust comparable weightings and influence valuation predictions, enabling convergence toward a stable valuation-DOM equilibrium and allowing price modeling to reflect expected market friction levels.

In some non-limiting embodiments or aspects, the system enhances model confidence, stability, and robustness by computing cross-model consistency scores comparing outputs from valuation, DOM, and elasticity engines to identify conflict or drift requiring selective recomputation. Stabilization filters may enforce monotonic DOM behavior across increasing price points, generate volatility-adjusted DOM curves when local conditions exhibit high temporal variance, and propagate confidence bands across valuation, DOM, and elasticity outputs to produce coherent uncertainty representations.

### COMPARABLE-SELECTION LOGIC, NORMALIZATION, AND COMP-TIERING

In some non-limiting embodiments or aspects, the system selects comparable assets using a similarity engine configured to evaluate visual, structural, contextual, and temporal embeddings, assigning similarity scores to candidate comparables based on weighted combinations of embedding distances, attribute deltas, and micro-neighborhood compatibility. Ranked candidate sets may be filtered using configurable criteria including location radius, school-zone consistency, structural class, market-velocity thresholds, and competitive-listing density, with nearest-neighbor embeddings retrieved from a vector database and optionally cross-validated across multiple embedding families to reduce selection bias.

In some non-limiting embodiments or aspects, the system performs comp-tiering by grouping comparables into confidence-based tiers according to similarity-score distributions, attribute-completeness scores, contextual coherence, and data freshness. Tier-1 comparables represent the highest similarity and strongest predictive influence, while lower tiers provide secondary or fallback support. The system may manage comp clusters by grouping similar comparables and selecting cluster centroids to avoid redundancy, dynamically adjusting similarity thresholds based on local inventory strength, available comp-pool size, and valuation-confidence requirements, and suppressing recalculation when update events do not materially alter similarity rankings or tier membership.

In some non-limiting embodiments or aspects, the system normalizes property attributes across comparables by generating standardized feature vectors that correct for discrepancies in attribute reporting or measurement units, including square-footage normalization, age-adjusted depreciation coefficients, renovation-adjustment mappings, and neighborhood-contour normalization to account for micro-market boundaries and proximity-based pricing behavior. Temporal alignment may be applied to normalize sale dates by adjusting historical prices using appreciation or decline factors, while outlier likelihood scores are used to suppress comparables with anomalous pricing behavior or insufficient data quality.

In some non-limiting embodiments or aspects, the system computes adjustment coefficients representing condition differences, finish-level deltas, layout desirability, amenity deviations, and contextual corrections between the subject asset and each comparable. Adjusted comparable values may be used for regression-style valuation, similarity-weighted averaging, or machine-learning prediction functions. The system can compute comp-confidence scores based on data freshness, image coverage, and contextual precision; such scores influence weighting during valuation computation and may suppress low-confidence comparables even when similarity scores are high. Rule-based overrides can allow domain experts to enforce inclusion or exclusion policies for specific comparables when required.

In some non-limiting embodiments or aspects, the system generates a baseline valuation using weighted contributions from adjusted comparable values, condition indicators derived from image-analysis signals, contextual features (including neighborhood-contour embeddings and market-velocity inputs), and premium-feature multipliers for attributes such as view quality, waterfront adjacency, luxury finishes, or lot desirability. Valuation-confidence metrics may be computed from comp density, embedding coherence, temporal alignment, and structural completeness of input data, and valuation deltas and stability indicators may quantify how new events or signals shift predicted values and whether changes are driven by substantial new information versus minor statistical fluctuations or transient noise.

In some non-limiting embodiments or aspects, DOM and price-time elasticity modeling operate on the same comp-adjusted and contextualized feature space. The system may generate DOM curves and price-time elasticity surfaces across a range of hypothetical list prices, representing expected buyer engagement, offer likelihood, and time-to-sale behavior, and compute uncertainty intervals or volatility adjustments based on inventory levels, seasonality, and localized buyer-activity patterns. Optimization logic can treat elasticity surfaces as objective functions to identify list-price bands or recommended price points that balance expected return, sale speed, and seller-goal weighting parameters, including detection of inflection points where small price changes materially improve expected time-to-sale.

In some non-limiting embodiments or aspects, valuation modeling incorporates market-velocity mapping, competitive-index scores, and counterfactual scenarios that estimate price or DOM under alternative pricing strategies, renovation simulations, or macro-market conditions. Multi-run smoothing and dynamic feature-weight scaling may be applied to reduce noise in volatile markets and to shift emphasis among comps, condition features, and contextual signals based on data completeness. Valuation resolution processes may finalize outputs only after verifying that projection surfaces, DOM curves, and comp adjustments satisfy configured stability, governance, and version-alignment requirements.

In some non-limiting embodiments or aspects, the comp-selection engine and valuation modules integrate with the explainability and state-governance framework described herein by logging comp-selection decisions, ranking orders, adjustment coefficients, and version identifiers to support audit trails, deterministic replay, and generation of explanation fields describing why each comparable was selected, adjusted, or rejected.

### Output, Dissemination, Avatar Generation & User Interfaces

In some non-limiting embodiments or aspects, the system generates an explainable valuation package comprising the valuation, DOM prediction, elasticity surface, and validated reasoning object.

In some non-limiting embodiments or aspects, the valuation package may be formatted as structured data, narrative text, charts, or visual comparison modules.

In some non-limiting embodiments or aspects, dissemination module 160 transforms valuation outputs into UI-ready elements for display on web, mobile, or API endpoints.

In some non-limiting embodiments or aspects, the system outputs updated valuations in real time in response to ingestion events or competitive-market updates.

In some non-limiting embodiments or aspects, the system generates visualization modules showing comp comparisons, price distributions, or DOM trajectories.

In some non-limiting embodiments or aspects, dissemination logic adapts output presentation based on user type, such as novice users, professionals, analysts, or gameplay participants.

In some non-limiting embodiments or aspects, the system generates delta summaries describing how valuations changed relative to previous iterations.

In some non-limiting embodiments or aspects, updated outputs may include confidence intervals, stability indicators, and sensitivity explanations.

In some non-limiting embodiments or aspects, dissemination modules may provide downloadable reports comprising valuation details, narrative explanations, and related analytics.

In some non-limiting embodiments or aspects, the system may generate recommendation summaries describing pricing strategies aligned with the elasticity surface.

In some non-limiting embodiments or aspects, the system may deliver condensed explanations for interface components requiring rapid consumption. In some non-limiting embodiments or aspects, dissemination module 160 may generate multi-view outputs enabling toggling between valuation, comps, DOM, and explanation screens.

In some non-limiting embodiments or aspects, the system creates structured reasoning visualizations showing how each feature contributed to the final valuation. In another example, avatar-generation modules convert reasoning objects and narrative templates into animated or video-based explanations.

In some non-limiting embodiments or aspects, avatar explanations synchronize lip movement and gestures with narrative timing derived from reasoning objects. In another example, the video-synthesis interface combines scripts, visual cues, and AI-generated avatars to deliver personalized explanations.

In some non-limiting embodiments or aspects, the system supports different avatar personas such as instructor-mode, novice-friendly mode, or expert-commentary mode. In some avatar-driven explanations may incorporate graphical overlays illustrating comps, adjustments, or DOM curves. In some dissemination modules may integrate video explanations directly into the valuation output interface.

In some, the system provides tooltips, hover explanations, and interactive highlights tied to reasoning-object elements. In some dissemination components allow users to drill down into deeper valuation layers including comp adjustments and feature-level contributions.

In some non-limiting embodiments or aspects, output modules may generate auditor-facing compliance exports containing all state identifiers and reasoning-object metadata. In some dissemination logic may restrict or redact specific details for compliance or consumer-protection purposes.

In another example, the system may output uncertainty visualizations showing how predicted values vary across market scenarios. In some dissemination module 160 may aggregate outputs for multi-property views such as portfolios or neighborhood analytics.

In some non-limiting embodiments or aspects, the output subsystem may transmit valuation updates to partner applications, listing platforms, or third-party APIs. In some dissemination logic manages real-time streaming of valuation updates for dashboards requiring continuous refresh. In another example, the system may deliver scheduled or event-triggered valuation reports based on ingestion events or market movements. In some memory of prior valuations may be surfaced to users through historical charts or valuation-timeline components.

In some non-limiting embodiments or aspects, output modules may generate recommendation labels such as “optimal,” “aggressive,” or “conservative” based on price-time elasticity. In some, dissemination may include alerts triggered by material valuation changes, competitive-listing events, or updated sale outcomes. In some, user interfaces may integrate interactive sliders allowing users to explore how hypothetical pricing alters valuation or DOM trajectories. In some video-synthesis interface may generate multi-lingual avatar explanations using the same underlying reasoning object.

In some non-limiting embodiments or aspects, the system may log all disseminated outputs with associated state-version identifiers for audit tracing and replayability.

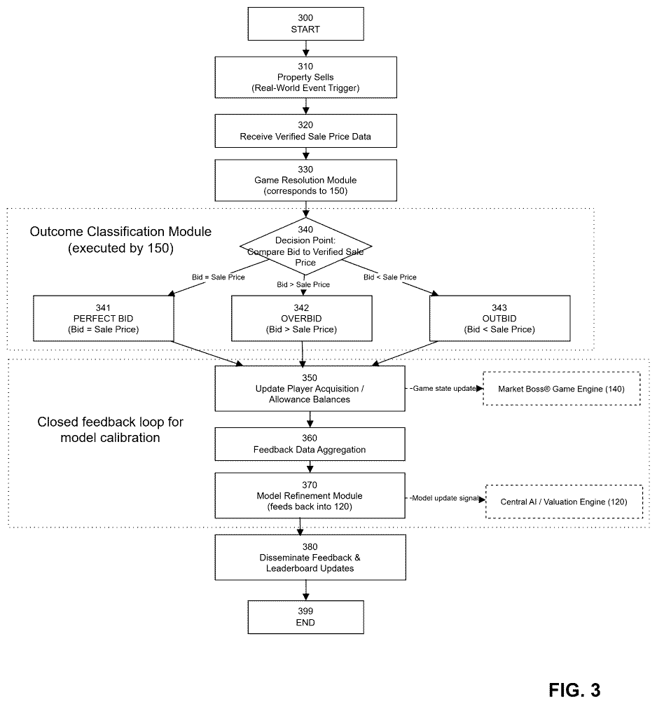

Referring now to FIG. 3, FIG. 3 illustrates a non-limiting embodiment of a Feature Analysis Module configured to transform raw property media into structured feature data, condition indicators, and image-embedding signatures used throughout the valuation pipeline. FIG. 3 depicts a sequence of staged machine-vision operations in which unstructured media is ingested, classified, scored, and converted into embedding vectors suitable for downstream comparable selection, valuation modeling, price-time analysis, and explainability generation.

In some non-limiting embodiments or aspects, the process begins with media ingestion 310, in which the system receives photographs, floor plans, panoramic images, video still frames, virtual-tour frames, or other property media sourced from the Data Ingestion Module 110 described in FIG. 1. Media ingestion 310 may include normalization of image resolution, format conversion, orientation correction, metadata extraction, and preprocessing operations such as color balancing or distortion correction.

In some embodiments, the normalized media is provided to an image-classification stage 320, which applies one or more trained machine-learning models to identify the content of each image. The classification module may determine room type (e.g., kitchen, bathroom, bedroom, living area), architectural style, amenities, materials (e.g., countertop type, flooring), fixtures, landscaping features, and notable interior or exterior characteristics. This stage produces categorical labels that index the images into semantically meaningful groups.

In some non-limiting embodiments or aspects, the classified imagery is then passed to a condition-scoring stage 330, which evaluates wear-and-tear indicators, renovation level, material quality, finish consistency, structural cues, and localized deterioration patterns. Condition scoring may be performed on a per-image or per-room basis, producing condition vectors that quantify the aesthetic and functional quality of the observed property elements. These scores may also account for lighting normalization, occlusion, or partial-view modeling, and may include confidence values associated with each predicted condition score.

In some embodiments, the output of the condition-scoring stage is provided to the feature-extraction stage 340, which computes quantitative descriptors of the property's attributes using aggregated visual signals. Example extracted features may include style descriptors, curb-appeal indicators, layout-coherence metrics, spatial-flow assessments, and aggregated quality or finish parameters. In some embodiments, these extracted features may be combined with structured fields ingested from listing records, thereby producing a comprehensive multimodal feature vector.

In some non-limiting embodiments or aspects, the system then applies an embedding-generation stage 350, which converts the classified, scored, and feature-annotated imagery into high-dimensional embedding vectors. These embeddings may be produced using convolutional networks, vision transformers, multimodal encoders, or contrastive-learning frameworks aligned with the broader valuation engine. The resulting image embeddings capture latent features such as style similarity, spatial configuration, visual appeal, and condition nuances that are not directly encoded in structured listing fields. The embedding-generation stage 350 outputs both single-image embeddings and aggregated room-level or property-level embeddings.

In some embodiments, the system evaluates whether the generated features and embeddings meet a required confidence level or data-completeness threshold at a decision stage 360. If the threshold is not met, the system may route the media or intermediate results to a human-review workflow or perform additional inferencing passes using adjusted confidence parameters, updated model weights, or alternative classification cascades.

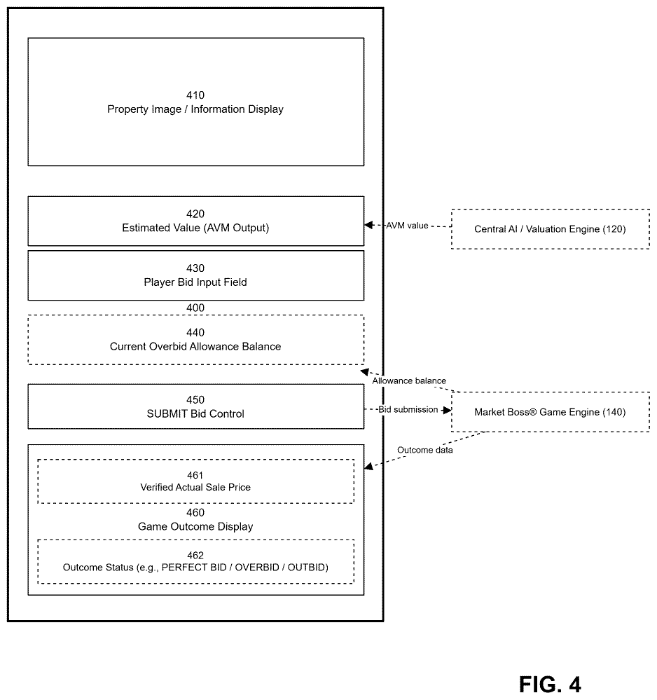

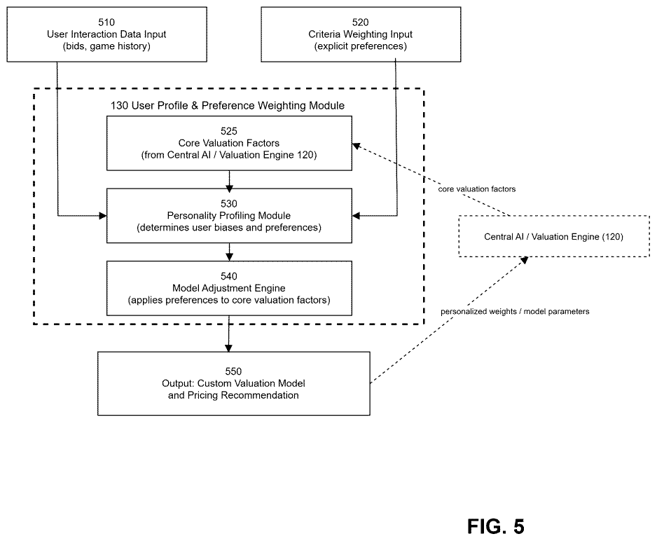

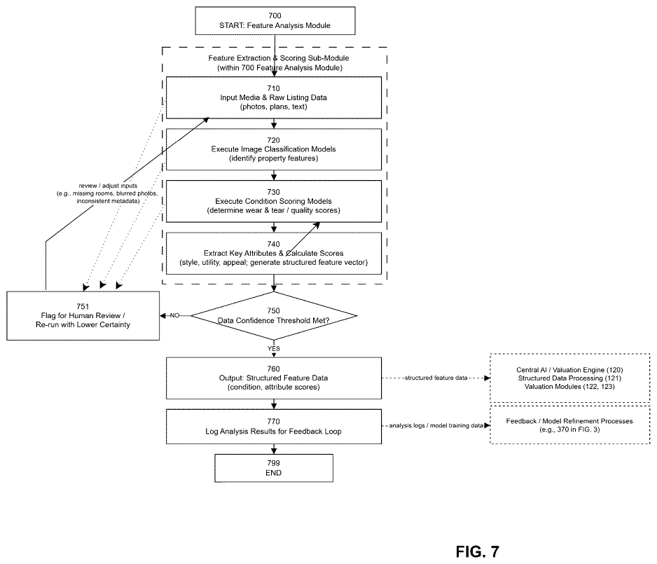

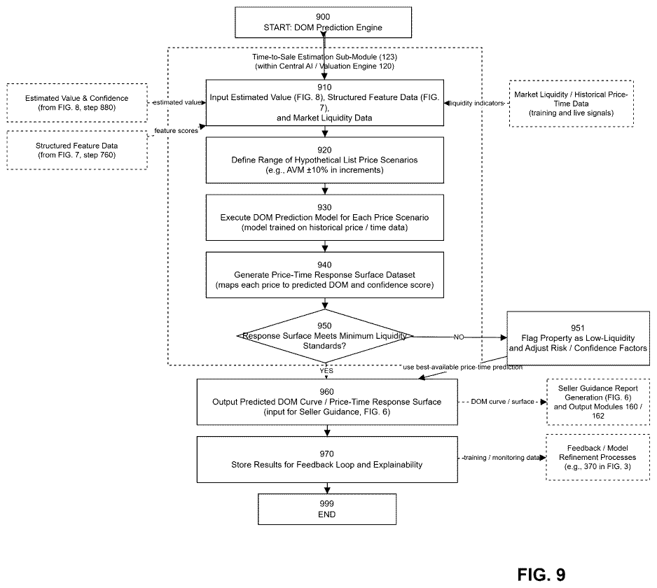

If the threshold is satisfied, the module outputs structured feature data 370, including condition scores, categorical labels, extracted attributes, image embeddings, and associated confidence indicators. These outputs form the feature vector consumed by downstream components, including the comparable-selection and market-timing module 122 of FIG. 4, the days-on-market prediction engine 123 of FIG. 5, and the explainability module 900 of FIG. 9. The output may also be written to the vector-embedding storage architecture described in FIG. 7.

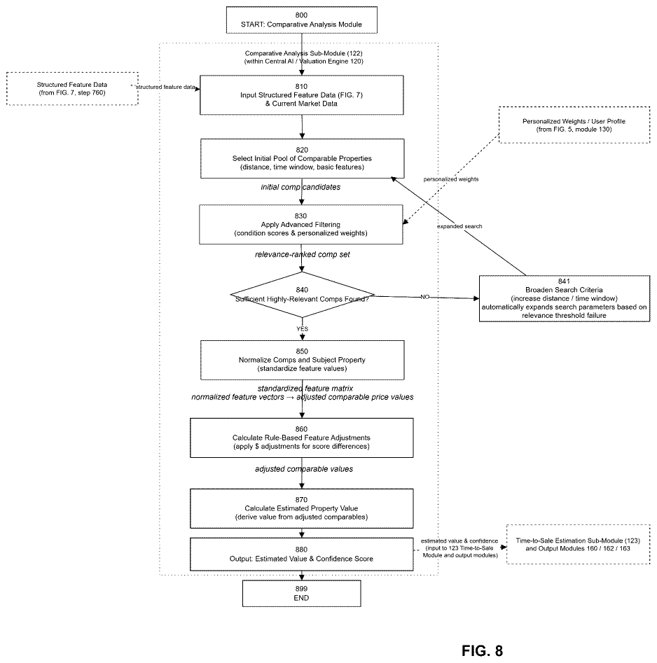

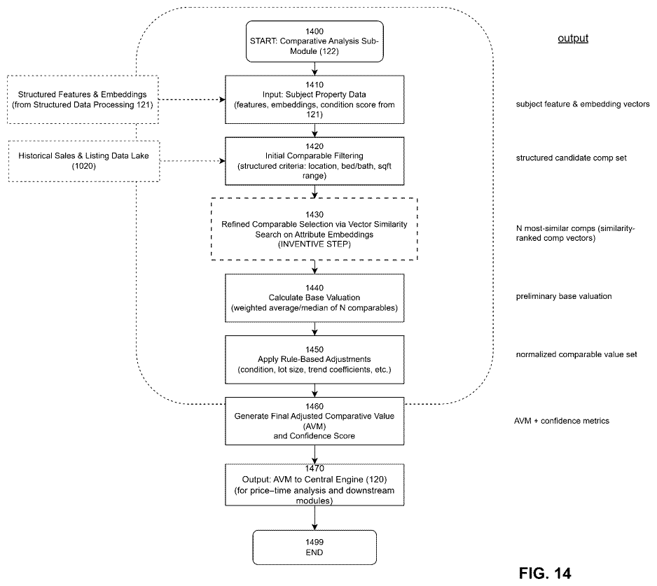

In some non-limiting embodiments or aspects, the module further performs logging and feedback capture 380, storing model-confidence values, extracted features, embeddings, and human-review results for use in continuous model retraining, calibration, or drift detection. Such feedback may be consumed by the event-driven recalibration processes described in FIG. 8 and FIG. 14.

Collectively, FIG. 3 demonstrates how the system converts unstructured visual media into structured, machine-understandable feature vectors, enabling high-resolution comparability, improved valuation accuracy, multi-scenario liquidity modeling, explainable AI outputs, and gameplay fairness through consistent feature extraction. The module's staged architecture provides deterministic processing, selective recomputation, confidence-gated output, and tightly integrated support for the broader valuation and gameplay frameworks described in FIGS. 1-15.

Referring now to FIG. 4, FIG. 4 illustrates a non-limiting embodiment of a Comparable-Selection and Adjustment Process configured to identify, evaluate, adjust, and synthesize comparable-property data to generate a valuation estimate for a subject property. The process shown in FIG. 4 represents the core operation of the comparable-selection and market-timing module 122 described in FIG. 1, and interacts directly with the upstream feature vectors and image embeddings produced by the Feature Analysis Module in FIG. 3.

In some non-limiting embodiments or aspects, the process begins with input aggregation 410, in which the system receives property feature data, contextual attributes, market conditions, image embeddings, and condition indicators generated in FIG. 3. These inputs may include room-type distributions, finish quality assessments, layout descriptors, and numerical features derived from structured listing fields. The aggregated input data forms the basis for similarity retrieval and adjustment computation.

In some embodiments, the system performs candidate-identification 420, retrieving potential comparable properties from a database of historical and active listings. Candidate identification may include geographic radius filters, school-zone boundaries, micro-neighborhood constraints, property-type matching, amenity filtering, and temporal market-period alignment. In some embodiments, additional filters may remove outliers or non-comparable properties based on configuration, style, age, renovation level, or other detected mismatches.

In some non-limiting embodiments or aspects, the candidate pool is refined at a vector-similarity stage 430, which retrieves embedding vectors stored in the vector-embedding database (FIG. 7) and computes similarity metrics between the subject property and each candidate. Similarity may be computed using cosine similarity, Euclidean distance, dot-product scoring, or transformer-encoded multimodal similarity measures. This stage allows the system to identify properties that are visually, structurally, or contextually similar to the subject property, even when structured data is incomplete or ambiguous. The output of this stage may include ranked similarity lists and threshold-based inclusion or exclusion decisions.

In some embodiments, the selected candidates proceed to a tiering and weighting logic stage 440, in which properties are assigned to comp tiers based on similarity scores, contextual comparability, recency, and data completeness. Tiering may incorporate rules or learned heuristics that separate primary comparables from secondary or tertiary comparables. Weighting factors may be applied based on signal quality, feature alignment, market-velocity characteristics, or variance across comp sets. The system may optionally compute confidence bands reflecting the robustness of each tier assignment.

In some non-limiting embodiments or aspects, the system next applies adjustment computations 450, in which differences between the subject property and each comparable property are quantified and normalized. Adjustments may account for square footage, bedroom and bathroom count, lot size, property age, renovation level, condition indicators, material quality, parking or yard features, and contextual differences such as proximity to amenities or school-district boundaries. Adjustments may be linear, nonlinear, rule-based, model-based, or a combination thereof. The output of this stage is an adjusted comp value for each comparable property.

In some embodiments, the adjusted comp values and tier-weighted scores are aggregated at a valuation synthesis stage 460, which computes a unified valuation estimate for the subject property. Valuation synthesis may include weighted averaging, regression modeling, neural-network aggregation, ensemble blending, or probabilistic modeling. In some embodiments, the system may also compute confidence intervals, median values, or multi-scenario valuation bands.

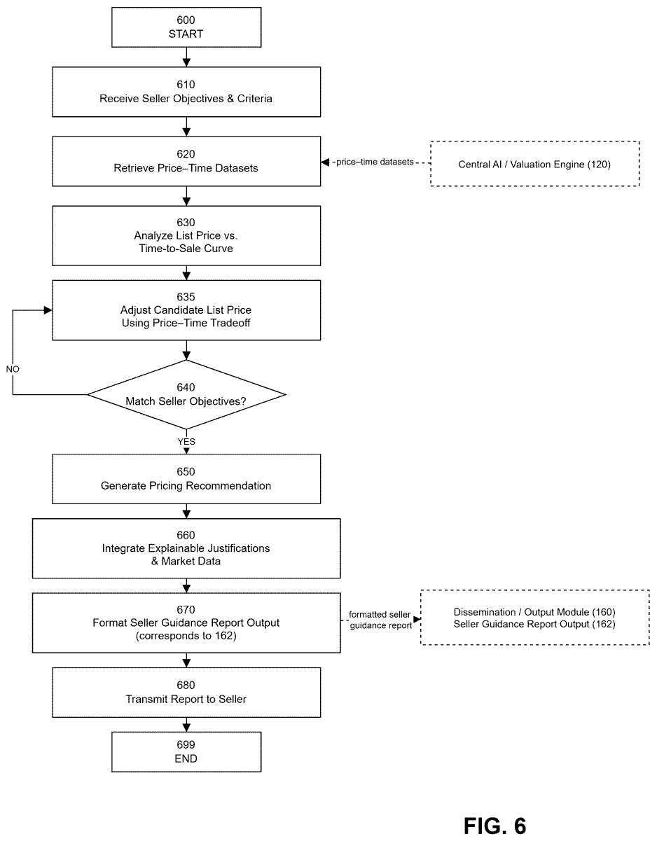

In another example, FIG. 4 further depicts an optional DOM and elasticity alignment stage 470, in which the valuation estimate is cross-referenced with days-on-market predictions and price-time elasticity surfaces generated in later pipeline stages (FIG. 5-6). This alignment may correct valuation anomalies, enforce temporal consistency, or determine whether the comp-adjusted value should be shifted based on current market velocity or expected time-to-sale.

In some embodiments, the system proceeds to an output-generation stage 480, in which the final valuation estimate, tiering data, comp-adjustment details, and confidence measures are packaged for downstream use. These outputs may be provided to the explainability engine of FIG. 9, the event-driven recalculation logic of FIG. 8, or the dissemination module of FIG. 1. The output may also include structured reasoning fields describing why particular comparables were selected, how adjustments were computed, and how comp tiers influenced the final valuation synthesis.

In some non-limiting embodiments or aspects, FIG. 4 also includes a feedback logging stage 490, which records similarity scores, adjustment deltas, weighting logic outcomes, and comp-tier structures for continuous model improvement. These logs may be consumed by the event-driven feedback module 150, enabling the system to identify model drift, adjust comp-selection heuristics, or refine embedding models over time. Feedback data may also be used for deterministic replay, allowing the system to reconstruct prior valuations or validate model decisions during auditing or regulatory review.

Overall, FIG. 4 demonstrates a structured and technically grounded mechanism for identifying, selecting, adjusting, and synthesizing comparable-property data, enabling high-fidelity valuations that integrate both structured and unstructured feature signals. The process uniquely leverages multimodal embeddings, dynamic adjustment heuristics, selective tiering logic, temporal market alignment, and deterministic reasonability checks that feed into explainability and gameplay systems illustrated in FIGS. 1-15.

As shown in FIG. 1, the comparable-selection and adjustment operations depicted in FIG. 4 are executed within the comparable-selection and market-timing module 122 of the central AI/valuation engine 120. These processes rely on upstream feature and embedding signals generated by module 121, retrieve similarity vectors from the vector-embedding database, and produce valuation outputs that feed into the explainability module 123, the orchestration layer 150, and the dissemination module 160 as part of the unified end-to-end workflow.

FIG. 5 illustrates a non-limiting embodiment of a days-on-market (DOM) prediction engine 500, which forms part of the comparable-selection and market-timing module 122 within the central AI/valuation engine 120 of FIG. 1. In some non-limiting embodiments or aspects, DOM prediction engine 500 receives as inputs an enriched feature vector representing the subject property, embeddings and normalized data for a selected set of comparable properties, historical market-velocity indicators, price-sensitivity features, and contextual micro-market variables generated upstream through modules 110, 121, and 122.

In another example, DOM prediction engine 500 includes a hazard-curve modeling component 510 configured to generate survival-analysis features from historical listing behavior. These features may include listing-persistence rates, absorption speeds, seasonality patterns, and hazard probabilities associated with price bands, property classes, or geographic subregions. Hazard-curve modeling component 510 may use parametric, semi-parametric, or non-parametric estimation, including Cox-style proportional hazard models, boosted survival ensembles, recurrent neural networks with time-decay, or transformer-based sequence predictors trained on temporal listing histories.

In some non-limiting embodiments or aspects, DOM prediction engine 500 includes a market-velocity normalizer 520 configured to incorporate market-wide indicators such as current inventory levels, median DOM for relevant cohorts, temporal absorption rates, buyer-traffic seasonality, and short-term competitive shifts. Normalizer 520 may recompute momentum indices or velocity deltas in real time as events are detected and propagated by event-driven feedback module 150.

In some non-limiting embodiments or aspects, DOM prediction engine 500 includes a price-position evaluator 530 configured to simulate the effect of multiple hypothetical list prices on predicted DOM outcomes. Evaluator 530 may compute a price-time elasticity function describing the expected change in DOM given incremental adjustments above or below a recommended price anchor. This may include generating a set of DOM predictions across a grid or curve of price points to construct a price-versus-time response surface 540.

In some embodiments, price-time response surface 540 is generated by combining hazard-curve outputs with absorption models, competition-weighted scoring, and similarity-weighted DOM trajectories derived from comparable listings. The resulting multidimensional surface may be used to identify price points associated with optimal certainty bands, accelerated sale likelihood, or balanced exposure windows.

In some embodiments, DOM prediction engine 500 further includes a confidence-band estimator 550 configured to produce uncertainty intervals, stability bands, or credibility scores for each predicted DOM value. These outputs may be derived from ensemble variance, Monte-Carlo dropout, bootstrap resampling, or multi-model calibration protocols.

In some non-limiting embodiments or aspects, DOM prediction engine 500 generates final DOM outputs 560, which may include:
a predicted DOM value at the recommended price,
a DOM curve visualizing expected time-to-sale across pricing scenarios,
confidence intervals for each predicted point,
a price-time elasticity score, and
supporting features used for downstream explainability.

DOM outputs 560 may be passed to the explainability and reasoning module 123 for integration into structured reasoning objects, including “DOM drivers,” “price-time sensitivity drivers,” or “market-velocity contributors.”

In some embodiments, the outputs produced in FIG. 5 may also be delivered to dissemination and output module 160 for transformation into valuation reports, pricing guidance summaries, CMA-style presentations, dashboards, and animated DOM visualizations. When gameplay functionality is enabled, DOM predictions may be transmitted to the Market Boss® game engine 140 to calibrate difficulty, confidence windows, and prediction-scoring ranges.

FIG. 6 illustrates a non-limiting embodiment of a list-price optimization module 600, which forms part of the comparable-selection and market-timing module 122 within the central AI/valuation engine 120 of FIG. 1. In various embodiments, list-price optimization module 600 receives as inputs the valuation estimate, the DOM predictions, the price-time elasticity surface, and the contextual and comparable-property features generated upstream by modules 121 and 122.

In another example, list-price optimization module 600 includes a price-curve generator 610 configured to sample predicted valuations and DOM trajectories across a range of hypothetical list prices. The generator may apply interpolation or spline-based modeling to derive a smooth price-time curve and quantify sensitivity to incremental adjustments above and below candidate list prices.

In some embodiments, optimization module 600 includes a tradeoff analysis engine 620 that evaluates competing objectives, such as minimizing expected DOM, maximizing sale-price certainty, balancing exposure time with pricing aggressiveness, or targeting a specific probability of sale within a desired window. Tradeoff analysis engine 620 may combine elasticity surfaces, hazard-model projections, absorption patterns, and similarity-weighted outcomes from comparable listings.

In some embodiments, module 600 includes a seller-goal weighting component 630 for incorporating user-provided or system-derived objectives, including “sell fastest,” “optimize for certainty,” “maximize price,” or “balanced.” Component 630 may adjust the underlying optimization algorithm to emphasize price stability, probability of sale, competitive positioning, or risk-weighted returns.

In another example, optimization module 600 includes a competitive-landscape modeler 640 that assesses real-time competition around the target pricing zone. Modeler 640 may incorporate active listings, pending listings, recently closed sales, buyer-traffic patterns, and market velocity into its objective function, enabling the recommended price to reflect competitive intensity and positioning.

In some embodiments, list-price optimization module 600 includes a recommendation engine 650 configured to identify one or more recommended pricing points, including:
a primary recommended list price aligned with user or system goals,
an aggressive lower-bound price associated with rapid selling probability,
an aspirational upper-bound price associated with slower expected DOM, and
a price-stability band indicating where predicted outcomes remain relatively stable.

Recommendation engine 650 may also compute likelihood-of-sale metrics, confidence intervals, and risk-adjusted pricing alternatives.

In some embodiments, list-price optimization module 600 generates final optimization outputs 660, which may include a recommended price, a pricing band or envelope, a tradeoff chart, a price-versus-DOM sensitivity map, and an accompanying set of intermediate signals used by the explainability engine 123. These outputs may be structured for both algorithmic consumption and human-interpretable presentation.

In another example, optimization module 600 may stream updated pricing recommendations to dissemination and output module 160, which may render the results as charts, textual explanations, CMA-style summaries, narrative guidance, or avatar-based walkthrough videos. When gameplay functionality is enabled, pricing recommendations may be transmitted to Market Boss® game engine 140 to calibrate contest difficulty, define tolerance windows, or update training segments for professional-mode users.

As illustrated in FIG. 1, list-price optimization module 600 of FIG. 6 operates within comparable-selection and market-timing module 122 of the central AI/valuation engine 120, consuming valuation, DOM, and elasticity outputs and producing recommended pricing positions, tradeoff analyses, and structured pricing advisories for delivery through dissemination and output module 160 and, in some embodiments, to Market Boss® game engine 140.

FIG. 7 illustrates a non-limiting embodiment of a vector-embedding storage architecture 700, which supports the central AI/valuation engine 120 of FIG. 1 by providing persistent, versioned, and similarity-search—optimized storage for multimodal embeddings. In some non-limiting embodiments or aspects, architecture 700 is configured to ingest, store, retrieve, and manage embeddings generated by feature-extraction and photo-analysis module 121 and explainability module 123.

In some embodiments, vector-storage subsystem 710 stores structured feature vectors representing image embeddings, text embeddings, contextual embeddings, comp-adjustment signatures, or composite multimodal representations. Subsystem 710 may include memory-mapped index structures, approximate-nearest-neighbor (ANN) indexes, locality-sensitive hashing (LSH) tables, or hierarchical graph-based indexes to accelerate similarity-based retrieval for comparable-selection module 122.

In some non-limiting embodiments or aspects, media repository 720 stores the raw or preprocessed media associated with embedding generation, including property photos, video frames, panoramic images, 3D mesh slices, or condition-signal snapshots. Repository 720 may support caching, deduplication, and storage tiering (e.g., SSD for hot media, object storage for cold media) to optimize retrieval performance for module 121.

In some embodiments, cached valuation-results store 730 maintains intermediate or finalized outputs from modules 121, 122, and 123, including valuation vectors, DOM trajectories, elasticity surfaces, and structured reasoning-object fragments. Store 730 may be used to support replay, backtesting, or incremental recomputation workflows initiated by event-driven feedback module 150.

In another example, version-tracking subsystem 740 maintains embedding lifecycle metadata, including version identifiers, timestamps, data-lineage records, dependency graphs, and drift indicators. Subsystem 740 may assign version numbers each time an embedding is regenerated due to updated images, competitive-market shifts, neighborhood-context changes, or algorithm updates.

In some embodiments, subsystem 740 includes an embedding-drift detector configured to compute similarity drift metrics between historical embeddings and newly generated embeddings to determine whether reuse is permissible. When drift remains below a configured threshold, downstream pipelines may reuse stored embeddings; when drift exceeds threshold, subsystem 740 may invalidate older embeddings and trigger regeneration via photo-analysis module 121 and comparable-selection module 122.

In some non-limiting embodiments or aspects, architecture 700 may support distributed storage across clusters, shards, or GPU-accelerated vector appliances, enabling large-scale, low-latency embedding retrieval in real-time. Architecture 700 may expose its functionality through APIs, service buses, or direct bindings used by valuation engine 120, event-driven feedback module 150, and reasoning engine 123.

In some embodiments, architecture 700 includes indexing strategies for different embedding modalities, supports tiered retention policies, and performs background maintenance tasks such as compaction, pruning of stale embeddings, or replication for fault tolerance. The architecture may also store training and validation embeddings for retraining machine-learning models.

As shown in FIG. 1, vector-embedding storage architecture 700 of FIG. 7 operates as a shared persistence layer for modules 121, 122, and 123 of central AI/valuation engine 120, enabling efficient similarity search, deterministic versioning, selective recomputation, and delivery of embedding-derived signals to dissemination and output module 160 and, in some embodiments, to Market Boss® game engine 140.

FIG. 8 illustrates a non-limiting embodiment of an event-driven orchestration layer 800 configured to monitor, classify, prioritize, and route update events to appropriate modules within system architecture 100. In another example, orchestration layer 800 continuously observes changes in listing data, market signals, media updates, competitive-asset movements, user interactions, or verified sale outcomes, and coordinates selective recomputation across valuation engine 120 and related modules.

In some embodiments, event-detection subsystem 810 ingests raw event signals originating from multiple sources, including data ingestion module 110, third-party listing services, market-velocity sensors, public-record updates, user inputs, or gameplay-derived behavioral events received from Market Boss® game engine 140. Subsystem 810 may classify incoming events into types such as price change, status update, new media ingestion, competitive-listing appearance, neighborhood-context change, or sale-verification event.

In some non-limiting embodiments or aspects, trigger-evaluation subsystem 820 determines whether an event satisfies one or more predefined trigger conditions. These trigger conditions may include embedding-staleness thresholds, comp-volatility thresholds, update magnitudes, contextual drift, DOM-curve instability, algorithm revisions, or gameplay-dependent timing constraints. Subsystem 820 may assign an impact score estimating the expected downstream effect of the event.

In some embodiments, dependency-chain analyzer 830 constructs or references a dependency graph that models directional relationships among pipeline modules, including photo-analysis module 121, comparable-selection and market-timing module 122, explainability module 123, and model-state representations stored in the vector-embedding database. Analyzer 830 may determine which modules must be recomputed, which may reuse stored embeddings, and which may bypass computation entirely based on updated data dependencies.

In another example, workflow-routing subsystem 840 dispatches recomputation tasks to the appropriate modules within valuation engine 120. For example, when new images arrive, subsystem 840 may route tasks to module 121; when competitive-market activity shifts, subsystem 840 may route tasks to module 122; when valuation deltas exceed defined thresholds, subsystem 840 may route tasks to module 123 to generate new reasoning objects.

In some non-limiting embodiments or aspects, adaptive-branching subsystem 850 determines dynamic execution paths based on event priority, concurrency constraints, or resource availability. Subsystem 850 may decide whether to perform full-pipeline recomputation, selective recomputation, real-time refresh, batch processing, or deferred update operations. In some embodiments, subsystem 850 may synchronize with cloud-scaling services to ensure real-time responsiveness under heavy event load.

In some embodiments, state-governance coordinator 860 enforces consistency rules ensuring that all updated outputs correspond to the correct version of embeddings, contextual signals, comparable selections, and reasoning-object structures. Coordinator 860 may record state transitions, version identifiers, timestamps, and propagation scopes to support deterministic replayability and auditability.

In some non-limiting embodiments or aspects, orchestration layer 800 includes a feedback-integration subsystem 870 that receives gameplay-driven behavioral signals, such as bid-bias patterns, prediction errors, streak analytics, or professional-mode user strategies, and routes them to valuation engine 120 for model refinement or calibration.

In some embodiments, event-logging and visualization subsystem 880 records each detected event, the modules affected, the recomputation operations triggered, and the resulting valuation or gameplay impacts. These logs may support debugging, forensic analysis, compliance workflows, or user-facing transparency dashboards.

As shown in FIG. 1, the event-driven orchestration layer 800 of FIG. 8 corresponds to event-driven feedback module 150 and coordinates selective recomputation for modules 121, 122, and 123 within central AI/valuation engine 120, manages state synchronization across system 100, and delivers updated results to dissemination and output module 160 and, in some embodiments, to Market Boss® game engine 140.

FIG. 9 illustrates a non-limiting embodiment of an explainable-model-output engine 900 configured to transform analytical signals generated by the central AI/valuation engine 120 into structured, validated, human-interpretable explanation objects. In some non-limiting embodiments or aspects, engine 900 consolidates signals derived from image analysis, attribute scoring, comparable-selection logic, market-timing predictions, DOM-curve modeling, and elasticity-surface computation to produce unified reasoning objects with deterministic internal structure.

In some embodiments, multimodal signal aggregation subsystem 910 receives heterogeneous analytical outputs generated across modules 121, 122, and 123. These inputs may include condition scores, room-type indicators, comp-tiering rationales, feature-adjustment computations, market-velocity features, DOM-trajectory drivers, elasticity inflection points, valuation deltas, and confidence metrics. Subsystem 910 aligns these signals into a normalized representational format, resolving conflicts, deduplicating fields, and enforcing consistent dimensionality.

In some non-limiting embodiments or aspects, feature-compression and synthesis subsystem 920 compresses raw analytical signals into semantically meaningful explanation fields. Compression may remove redundant attributes, collapse multi-stage analytical chains, identify dominant predictors, compute weighted contributions, or summarize relevant comp relationships. Subsystem 920 may generate structured fields describing drivers such as location influence, condition premium, renovation-level adjustments, comp-range justification, market-velocity effects, DOM-risk factors, price-elasticity recommendations, or confidence thresholds.

In some embodiments, reasoning-object constructor 930 builds a hierarchical explanation object populated with synthesized fields. The explanation object may include valuation rationales, DOM justification sections, comp-selection narratives, model-drift indicators, version identifiers, or elasticity-curve reasoning. Constructor 930 preserves module provenance, enabling traceability from final explanation back to individual analytical operations.

In some non-limiting embodiments or aspects, deterministic schema validator 940 enforces compliance with a predefined reasoning-schema template. The validator may: (i) ensure presence of required fields, (ii) confirm correct field ordering and formatting, (iii) validate type constraints, (iv) detect missing or contradictory signals, and (v) compute a structural-consistency score. Objects failing validation may be regenerated, revised, or substituted with fallback templates to maintain reliability and auditability.

In some embodiments, narrative-generation subsystem 950 converts validated reasoning objects into natural-language explanations, bulleted summaries, graphical valuation breakdowns, or storytelling structures. Narrative generation may incorporate rule-based phrasing, templated constructs, or machine learning-driven language generation optimized for clarity, determinism, and compliance.

In some non-limiting embodiments or aspects, multimedia-synthesis subsystem 960 prepares the reasoning object for avatar-based video output, animated walkthroughs, audio narration, or augmented-reality overlays. Subsystem 960 may map explanation fields to timing sequences, gesture cues, visual frames, or camera-angle templates used by external avatar-generation or video-synthesis modules.

In some embodiments, export and delivery subsystem 970 formats the validated explanation object and associated multimedia for dissemination to module 160. Supported formats may include JSON, XML, protobuf structures, PDFs, CMA-style comparative sheets, valuation dashboards, mobile UI panels, interactive charts, or API responses for partner integrations.

In another example, logging and version tracking subsystem 980 records the version identifiers, model signatures, input dependencies, and transformation history associated with each generated explanation object. These records may support deterministic replayability, compliance verification, quality assurance, and debugging.

As shown in FIG. 1, the explainable-model-output engine 900 of FIG. 9 corresponds to the explainability and reasoning module 123 within central AI/valuation engine 120 and generates structured reasoning objects, validated schema-compliant explanations, narrative outputs, and multimedia-ready content for dissemination through module 160 and, in some embodiments, for gameplay or training interfaces managed by game engine 140.

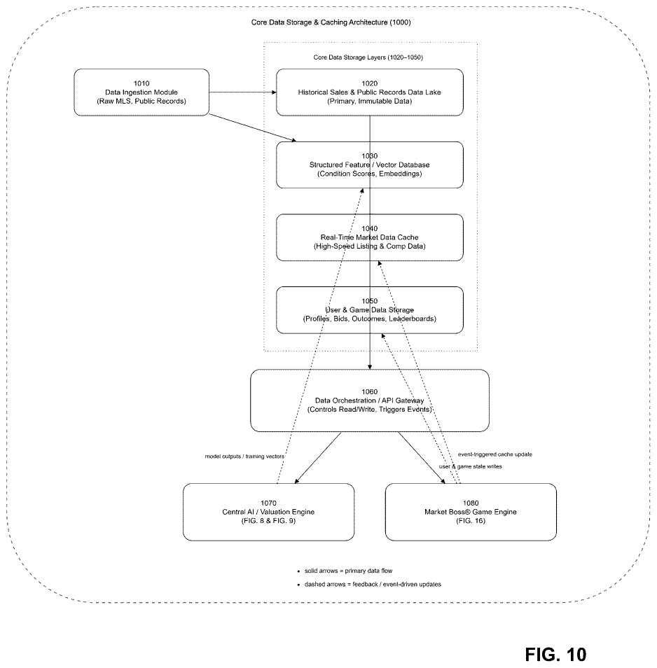

FIG. 10 illustrates a non-limiting embodiment of an avatar-generation module 1000 configured to transform structured reasoning objects, narrative scripts, visual-style templates, and timing instructions into avatar-based multimedia content. In some non-limiting embodiments or aspects, avatar-generation module 1000 receives validated reasoning objects from explainable-model-output engine 900 and constructs multimodal video or animated presentations synchronized with the system's valuation or gameplay outputs.

In some embodiments, theme- and persona-selection subsystem 1010 selects an avatar style consistent with user preferences, brand identity, contextual storytelling needs, or regulatory constraints (e.g., formal appraisal mode, educational mode, entertainment mode). Subsystem 1010 may retrieve predefined personas (e.g., professional analyst, coach, animated character) or dynamically generate new personas using embedding-based style transfer. Selection may depend on user history, gameplay tier, expertise level, or accessibility settings.

In some non-limiting embodiments or aspects, style-vector and prompt-processing subsystem 1020 transforms textual or structured style instructions into internal latent representations. These style vectors may encode parameters such as avatar ethnicity, clothing, lighting, rendering style (e.g., photorealistic, cel-shaded, illustrative), tone, emotional expression, or narration cadence. Subsystem 1020 may integrate user-provided prompts, system-generated prompts derived from reasoning objects, or dynamically inferred prompts based on market conditions or gameplay events.

In some embodiments, script-alignment subsystem 1030 receives narrative text produced by narrative-generation subsystem 950 and aligns the script to animation timelines, scene transitions, and gesture cues. Subsystem 1030 may parse narrative segments, identify emphasis markers, map explanation emphasis to avatar gestures, and construct a timing graph referencing scene durations, transition sequences, and synchronization points. Script alignment may include phoneme mapping for lip synchronization when voice narration is present.

In some non-limiting embodiments or aspects, motion and gesture engine 1040 generates animation sequences for facial expressions, lip movements, body gestures, and camera transitions. Motion engine 1040 may utilize procedural animation, keyframe sequences, motion-capture libraries, or transformer-based gesture-generation models. The engine ensures that gestures correspond to narrative meaning—e.g., highlighting valuation drivers, contextual changes, pricing strategy insights, or gameplay outcomes.

In some embodiments, rendering and composition subsystem 1050 synthesizes the final avatar frames using 2D, 3D, or hybrid rendering techniques. Subsystem 1050 composites avatar layers with background scenes, overlays valuation charts, inserts visual indicators (e.g., arrows, highlights, DOM curves), and applies lighting and shading models. Background scenes may be static templates, dynamic visualizations, or context-sensitive environments selected based on the property characteristics or gameplay context.

In some non-limiting embodiments or aspects, voice-synthesis subsystem 1060 converts narrative text into natural-sounding speech. Voice output may use cloned voices, multilingual models, emotional-tone controls, or accessibility-optimized variants. Subsystem 1060 ensures alignment between speech and avatar lip movements, generating a synchronized audiovisual stream.

In some embodiments, audiovisual integration subsystem 1070 merges video frames, narration audio, gesture timelines, scene transitions, and overlays into a cohesive multimedia output. Subsystem 1070 may generate MP4 files, GIFs, animated WebM outputs, AR/VR-ready scenes, or real-time video streams. Metadata may include timing vectors, version identifiers, and reasoning-object references for auditability and deterministic replay.

In some non-limiting embodiments or aspects, delivery and export subsystem 1080 formats the generated video for delivery through dissemination module 160. Supported formats may include API-delivered media URLs, downloadable content, in-app playback frames, embedded video widgets, or streaming endpoints suitable for mobile devices, desktop environments, gaming consoles, AR displays, or interactive kiosks.

In some embodiments, logging and provenance subsystem 1090 records the mapping between reasoning objects, script versions, animation parameters, and final video outputs. This provides traceability for compliance, debugging, personalization, or iterative model improvement. Logs may include persona ID, theme vector, rendering model version, narration settings, and scene composition metadata.

As shown in FIG. 1, the avatar-generation module 1000 of FIG. 10 corresponds to multimedia-generation components within dissemination and output module 160 and is functionally coupled to explainability module 123, allowing the system to convert structured reasoning outputs into synchronized avatar-driven video explanations for valuation workflows, user education, or optional gameplay environments supported by game engine 140.

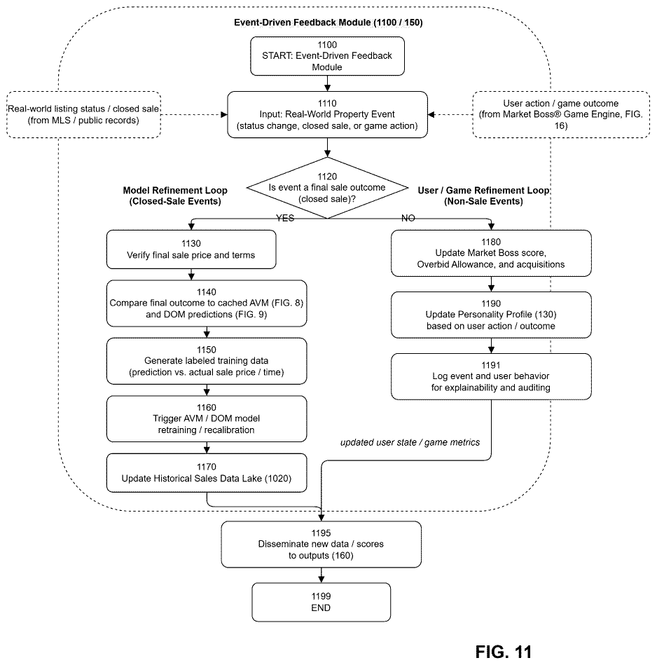

FIG. 11 illustrates a non-limiting embodiment of a background-scene generator 1100 configured to produce dynamic visual environments used in avatar-based explanations, instructional content, valuation summaries, or gameplay-related multimedia. In another example, the background-scene generator 1100 transforms textual prompts, property metadata, narrative cues, or system-defined templates into high-quality scenes that complement avatar-rendered video outputs.

In some embodiments, prompt-ingestion and context-extraction subsystem 1110 receives one or more inputs including narrative text from script-alignment subsystem 1030, structured reasoning fields from explainability module 123, property attributes (e.g., architectural style, location, condition), market context (e.g., recent sale, competitive activity), or gameplay context (e.g., contest round type, difficulty tier). Subsystem 1110 parses these inputs and extracts relevant scene parameters such as aesthetic style, thematic tone, lighting characteristics, or environmental motifs

In some non-limiting embodiments or aspects, scene-template selection subsystem 1120 selects a base template from a library of predefined environments including studio backdrops, educational settings, animated classrooms, residential interiors, modern offices, real-estate-themed stages, or immersive virtual environments. Selection may depend on the type of explanation being delivered—e.g., valuation analysis, DOM trends, comp-tier adjustments, strategic gameplay guidance, or tutorial modes.

In some embodiments, generative-scene synthesis subsystem 1130 produces novel backgrounds using machine-learning models such as diffusion models, GANs, transformer-based image synthesizers, or procedural rendering engines. Subsystem 1130 may adjust scene components in real time based on reasoning-object content, such as dynamically generating neighborhood-style backdrops, abstract representations of elasticity curves, or stylized comp-matching illustrations. The output may include multi-layered RGB images, segmentation maps, or depth-aware renders suitable for 2D or 3D environments.

In some non-limiting embodiments or aspects, personalization and accessibility subsystem 1140 customizes scenes according to user settings, accessibility requirements, or gameplay tiers. For example, the subsystem may simplify backgrounds for visually impaired users, enhance contrast for small-device displays, or apply branded color palettes for enterprise deployments. Gameplay variations may include thematically stylized scenes (e.g., “championship mode,” “beginner mode,” or “market-volatility challenge mode”).

In some embodiments, spatial-compositing subsystem 1150 prepares background layers for integration with avatar imagery generated by subsystem 1050. Spatial compositing may include depth-aware masking, parallax effects, perspective correction, and light-matching operations to ensure the avatar's rendering is visually consistent with the background. Subsystem 1150 may also insert floating UI elements such as arrows, charts, DOM curves, comp maps, or pricing overlays.

In some non-limiting embodiments or aspects, animation and transition subsystem 1160 allows backgrounds to incorporate animated elements such as moving charts, flowing gradients, ambient lighting shifts, or interactive tutorial steps. This subsystem synchronizes its animations with narrative timing and gesture cues from motion and gesture engine 1040, enabling cohesive multimedia explanations.

In some embodiments, optimization and export subsystem 1170 refines background scenes for the target delivery format. Optimization may include resolution scaling, color-space conversion, frame-rate adjustments, or compression suitable for mobile, desktop, smart TV, VR/AR devices, gaming consoles, or embedded user-interface components. Subsystem 1170 outputs background assets in formats such as PNG, JPEG, layered PSD, depth-enabled EXR, or animated WebM sequences.

In some non-limiting embodiments or aspects, scene-tracking and versioning subsystem 1180 stores metadata linking each generated background to corresponding reasoning-object IDs, avatar themes, script versions, and rendering configurations. This supports deterministic replayability, compliance auditing, revision tracking, and debugging across distributed deployments.

As shown in FIG. 1, the background-scene generator 1100 of FIG. 11 corresponds to multimedia-generation components of dissemination and output module 160 and operates in conjunction with avatar-generation module 1000 to construct synchronized, context-aware visual scenes that accompany avatar-rendered explanations derived from explainability module 123 and may additionally support gameplay interfaces mediated by game engine 140.

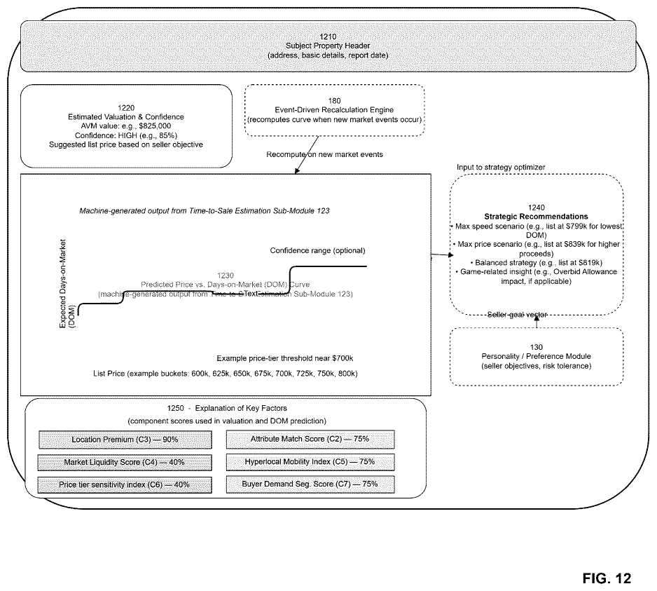

FIG. 12 illustrates a non-limiting embodiment of a motion-prompt engine 1200 configured to generate, refine, and synchronize avatar gestures, posture adjustments, facial expressions, and micro-animations aligned with narrative scripts, valuation explanations, and gameplay-related content. In some non-limiting embodiments or aspects, the motion-prompt engine ensures that avatar movement is semantically consistent with the reasoning-object fields generated by explainability module 123 and visually synchronized with the narrative and instructional content produced by dissemination and output module 160.

In some embodiments, gesture-intent extraction subsystem 1210 receives motion cues derived from structured reasoning objects, script timing, user role (e.g., novice, pro-mode), scene context, or gameplay state. Subsystem 1210 converts linguistic or symbolic markers—such as emphasis tags, sentiment fields, or numeric deltas—into actionable gesture intents. For example, an elasticity-curve rise may map to an upward hand motion, while a large comp-adjustment delta may map to widening arm gestures.

In some non-limiting embodiments or aspects, gesture-library selection subsystem 1220 retrieves one or more candidate gestures or pose sequences from a motion library containing thousands of pre-captured or procedurally generated movements. The library may include pointing motions, explanatory sweeps, body shifts, acknowledgments, chart-referencing gestures, instructional poses, celebratory animations (e.g., gameplay win), or empathetic cues (e.g., DOM-increase explanations). Gesture selection may be governed by semantic tags, animation constraints, avatar style, or target device form factors.

In some embodiments, procedural-motion synthesis subsystem 1230 generates intermediate or entirely new gestures using inverse kinematics (IK), physics-aware solvers, transformer-based motion models, or diffusion-based pose interpolators. Subsystem 1230 may refine gesture amplitude, timing, rhythm, smoothness, hand orientation, or head tracking to ensure naturalistic delivery across avatars of different proportions or animation styles.

In some non-limiting embodiments or aspects, motion-timing and alignment subsystem 1240 synchronizes gesture execution with narrative timing, scene transitions, and script-sentence boundaries. This subsystem ensures that gestures begin, peak, and conclude at appropriate narrative moments. For example, during valuation-explanation sequences, a gesture may coincide with the verbalization of a key factor (e.g., “market velocity increased . . . ”), whereas in gameplay scenarios, the timing may synchronize with scoring reveals or leaderboard changes.

In some embodiments, emotion and expression modulation subsystem 1250 applies facial-expression adjustments—including brow movement, eye gaze, lip shapes, micro-expressions, and emphasis cues—based on script tone, reasoning-object sentiment, or user-selected avatar personality. The subsystem may also modulate expression intensity depending on device size, accessibility settings, or cultural preferences.

In another example, physical-constraints subsystem 1260 validates movement feasibility across avatar body types, clothing models, environmental lighting, and background-scene geometry. Subsystem 1260 may prevent clipping, unnatural joint angles, or overly rapid transitions that may appear visually jarring when composited with background-scene outputs from FIG. 11.

In some embodiments, gesture-scene synchronization subsystem 1270 aligns gesture trajectories with spatial markers embedded in the generated scene (e.g., DOM curve locations, comp-map overlays, directional arrows, elasticity charts). This enables the avatar to visually reference on-screen elements with pointing, circling, or highlighting gestures that enhance user comprehension.

In another example, export and optimization subsystem 1280 produces motion-prompt metadata for use by downstream rendering pipelines. This subsystem may output gesture sequences in formats such as JSON motion descriptors, BVH animation files, skeletal-animation clips, blendshape trajectories, or proprietary interpolation formats. Optimization may include compression, smoothing filters, arc-correction, or re-timing for mobile or low-bandwidth environments.

In some embodiments, motion-versioning subsystem 1290 stores timing maps, motion descriptors, and version identifiers linked to corresponding reasoning-object versions, scripts, avatar themes, and scene backgrounds. This ensures deterministic replay, auditing, and consistent recomputation across distributed environments or future valuation updates.

As shown in FIG. 1, the motion-prompt engine 1200 of FIG. 12 corresponds to multimedia-generation components within dissemination and output module 160 and interoperates with avatar-generation module 1000, scene-generation module 1100, and script-alignment subsystems derived from explainability module 123 to produce synchronized, context-aware avatar animations for valuation explanations and gameplay-related multimedia.

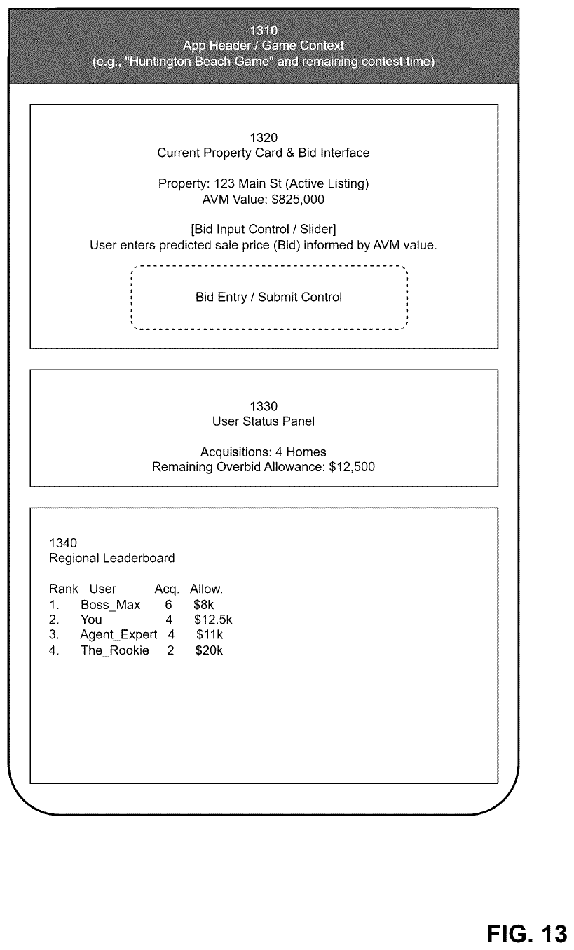

FIG. 13 illustrates a non-limiting embodiment of a personality profiling and preference-modeling module 1300 configured to ingest user-related signals, infer preference structures, and generate personalized weighting profiles used throughout valuation workflows, explanation delivery, gameplay tuning, and user-interface adaptation., personality profiling module 1300 enhances the responsiveness and contextual relevance of the system by computing individualized preference vectors and behavioral signatures that adapt the analytical and communicative behavior of downstream modules.

In some embodiments, data-collection subsystem 1310 receives a plurality of user-related inputs including historical interaction logs, search behavior, property-view histories, valuation exploration paths, refinement actions (e.g., adjusting filters, highlighting rooms), sentiment responses, tutorial completions, and optional gameplay behaviors. Subsystem 1310 may additionally ingest demographic signals, device type, session metadata, and engagement-depth metrics to construct an initial behavioral fingerprint. Input data may be processed through normalization, deduplication, or privacy-preservation steps prior to modeling.

In some non-limiting embodiments or aspects, feature-extraction subsystem 1320 derives structured representations from user actions. These representations may include preference indicators such as renovation affinity, neighborhood-style preference, risk tolerance, price-sensitivity bands, reaction to DOM curves, or responsiveness to competitive-landscape cues. Subsystem 1320 may compute embeddings for users, sessions, or persona clusters using transformer encoders, sparse-signal extraction modules, or recurrent sequence models.

In some embodiments, preference-inference engine 1330 applies machine-learning models—including probabilistic preference models, weighted linear utilities, multi-armed bandit systems, hierarchical Bayesian estimators, or representation-learning architectures—to infer stable or context-dependent user preferences. The engine may compute preference weights assigning importance scores to variables such as condition, location, market timing, price elasticity, school-zone relevance, or interior attributes (e.g., kitchen finish, flooring type, natural light). The engine may further infer temporal preference drift, enabling models to adapt as user expertise increases or user circumstances change.

In some non-limiting embodiments or aspects, persona-classification subsystem 1340 categorizes users into one or more persona groups (e.g., “data-driven analyst,” “visual explainer,” “trend-sensitive buyer,” “fast-decision player,” “cautious investor,” etc.) based on extracted features and inferred preferences. Persona classifications may influence how valuations are displayed, how reasoning objects are narrated, how gameplay hints are provided, or how pricing recommendations are contextualized.

In some embodiments, criteria-weight generator 1350 produces one or more personalized weighting vectors used by valuation engine 120 to tune comp-selection logic, adjust DOM-sensitivity parameters, or modulate elasticity-surface explanations. Weighting vectors may also be consumed by explainability module 123 to tailor which explanation factors are emphasized for a given user—e.g., more visual features for a novice user versus more statistical features for an expert.

In some non-limiting embodiments or aspects, gameplay-preference subsystem 1360 adapts contest difficulty, hint delivery, scoring explanations, or avatar-based narrative content based on user behavior and preference signals. Subsystem 1360 may adjust gameplay pacing, frequency of educational content, or the extent of professional-mode insights surfaced to a user.

In some embodiments, feedback-integration subsystem 1370 incorporates downstream behavioral signals—such as changes in user accuracy over time, responsiveness to valuation updates, gameplay performance, or explicit rating feedback—to refine user profiles. This subsystem may maintain long-term user embeddings, update preference vectors, or retrain persona classifiers for improved accuracy.

In some non-limiting embodiments or aspects, preference-versioning subsystem 1380 stores version identifiers, timestamps, preference-weight histories, and persona-classification changes. This ensures deterministic replayability, supports compliance requirements, and enables longitudinal modeling of preference evolution.

In some embodiments, privacy-and-consent subsystem 1390 enforces user-consent constraints, anonymization rules, and data-minimization settings. This subsystem may filter signals available to module 1300 based on user profile settings, jurisdictional compliance requirements, or enterprise policy rules.

As shown in FIG. 1, personality profiling and preference module 1300 of FIG. 13 corresponds to optional user-modeling components that interoperate with ingestion module 110, valuation engine 120, explainability module 123, gameplay engine 140, and dissemination/output module 160 to adapt system behavior, outputs, narratives, and gameplay tuning based on inferred user preferences.

FIG. 14 illustrates a non-limiting embodiment of an event-driven feedback and model-refinement module 1400 configured to ingest real-world market events, gameplay-derived behavioral signals, and internal pipeline updates, and to coordinate recalculation, retraining, and synchronization across valuation, explainability, and gameplay subsystems. In some non-limiting embodiments or aspects, module 1400 ensures that system outputs remain current, coherent, and technically deterministic despite the continuous arrival of new data.

In some embodiments, market-event ingestion subsystem 1410 receives updates from listing services, transactional databases, property-record feeds, and partner systems. Events may include price changes, status changes, introduction of new competitive listings, ingestion of verified sale prices, market-velocity shifts, neighborhood-boundary updates, zoning changes, or newly available media. Subsystem 1410 may structure each detected change into an event object containing event type, timestamp, affected asset identifiers, change magnitude, and event provenance.

In some embodiments, gameplay-signal ingestion subsystem 1420 receives behavioral data produced by Market Boss® game engine 140. These behavioral signals may include user accuracy histories, bid-bias patterns, risk-tolerance indicators, strategic tendencies, pacing behavior, competition-mode performance, or responses to valuation hints and educational overlays. Subsystem 1420 may compute player embeddings, contest difficulty metrics, and market-sentiment approximations inferred from aggregated gameplay.

In some non-limiting embodiments or aspects, event-classification engine 1430 analyzes incoming event objects and behavioral signals to categorize them into classes such as “high-impact market shift,” “media update,” “price delta,” “competitive-listing emergence,” “gameplay performance deviation,” or “model-drift indicator.” Event-classification engine 1430 may apply anomaly-detection models, threshold comparisons, temporal change metrics, similarity-drift computations, or ensemble classifiers to determine whether an event warrants recalculation or model adaptation.

In some embodiments, dependency-graph subsystem 1440 constructs or updates a dependency chain mapping which downstream modules depend on the updated data. For example, an updated image set may require regeneration of embeddings and condition scores (module 121), followed by comp reselection (module 122), valuation recomputation (module 122), DOM prediction updates (module 123), elasticity-surface reconstruction (module 123), explainability refresh (module 123), and optional gameplay-state recalculation (engine 140). Subsystem 1440 ensures that recomputation follows a deterministic, ordered, and reproducible path.

In some non-limiting embodiments or aspects, recomputation-trigger subsystem 1450 evaluates event magnitude, drift thresholds, confidence losses, dependency-graph requirements, and stale-state identifiers to determine whether partial or full recomputation is required. Subsystem 1450 may activate selective recomputation sequences, skip redundant nodes, or postpone updates in low-impact scenarios to maintain high system efficiency.

In some embodiments, model-drift detection subsystem 1460 monitors statistical behavior of the valuation engine 120, embeddings stored in the vector-embedding database, DOM prediction outputs, elasticity surfaces, and gameplay performance data. Drift detection may compare new patterns against historical baselines, embedding-space distributions, prediction-error trajectories, or persona-cluster shifts. When drift exceeds thresholds, subsystem 1460 may issue alerts or initiate retraining events.

In some non-limiting embodiments or aspects, model-retraining pipeline 1470 leverages aggregated signals—including verified sale prices, updated market conditions, and gameplay-derived behavioral features—to update machine-learning models underlying modules 121, 122, and 123. Retraining may occur continuously, periodically, or on-demand, and may involve updating image-embedding encoders, comp-selection ranking models, DOM hazard models, price-elasticity predictors, or structured-reasoning generators.

In some embodiments, behavioral-feedback integration subsystem 1480 incorporates gameplay-derived insights into valuation and explainability flows. For example, if real-world consumer behavior reveals emerging preferences (e.g., increased sensitivity to market velocity, decreased tolerance for renovation needs), subsystem 1480 may adjust model priors, relevance weights, elasticities, or narrative emphasis within reasoning objects.

In some non-limiting embodiments or aspects, state-synchronization and logging subsystem 1490 records state transitions, version identifiers, event context, recomputation decisions, and downstream propagation. This subsystem ensures that all modules within system architecture 100 operate on coherent, contemporaneous states, enabling deterministic replayability, compliance auditing, and debugging.

As shown in FIG. 1, event-driven feedback module 150 corresponds to the expanded feedback and recalculation module 1400 illustrated in FIG. 14, which orchestrates event ingestion, behavioral-signal processing, dependency analysis, retraining logic, and selective recomputation across the central AI/valuation engine 120, the explainability engine 123, the Market Boss® game engine 140, and the dissemination and output module 160.

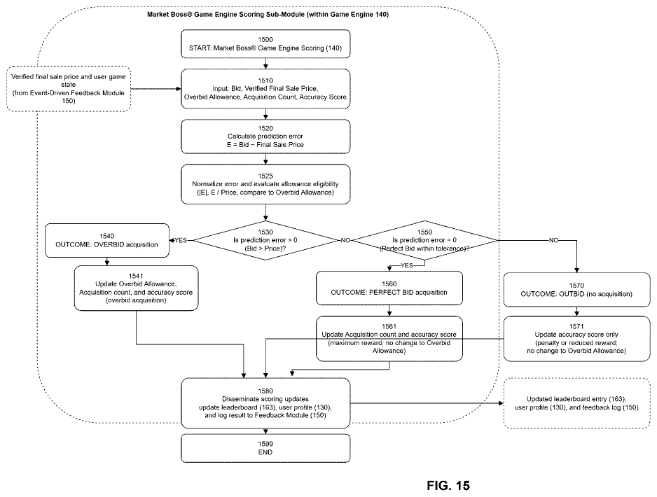

FIG. 15 illustrates a non-limiting embodiment of a scoring and outcome-determination engine 1500 configured to evaluate user predictions, adjudicate gameplay outcomes, update user-state variables, and propagate scoring information into downstream systems such as behavioral-feedback pipelines, retraining modules, and leaderboard management. In some embodiments, scoring engine 1500 forms a core component of Market Boss® game engine 140 shown in FIG. 1.

In some non-limiting embodiments or aspects, prediction-ingestion subsystem 1510 receives one or more user-submitted predicted sale prices for a target property or asset. Subsystem 1510 may validate input completeness, confirm that the user is eligible to submit a prediction, verify that the user possesses sufficient Overbid Allowance or similar gameplay resources, and timestamp each submission. The subsystem may enforce contest rules such as one-prediction-per-round, time-based submission windows, “locked-in” predictions, or tiered difficulty modes.

In some embodiments, prediction-error computation module 1520 computes a prediction error (PE) by comparing each submitted predicted sale price to a verified sale price obtained from ingestion module 110 or from external trusted-data sources. Prediction error may be represented in absolute form, relative form, percentage form, or z-score form. Module 1520 may also compute multi-dimensional error metrics, including directional bias (over/under), distance-to-target bands, and volatility-adjusted error. The computed error metric forms the basis for determining gameplay outcomes.

In some non-limiting embodiments or aspects, outcome-classification subsystem 1530 applies deterministic thresholds, tolerance bands, and rule-based logic to classify user outcomes. Classification categories may include:
Perfect Bid, in which the prediction error falls within a narrow tolerance band and triggers enhanced scoring, bonus rewards, or automatic property acquisition;
Correct-Range Outcome, in which the prediction falls within a broader permitted band;
Outbid Outcome, representing an underprediction where the user remains eligible for acquisition or bonus points depending on contest mode; and
Overbid Outcome, representing a prediction above the verified sale price, which may trigger penalties, allowance deductions, or forfeiture of property-acquisition rights.

Subsystem 1530 may also support additional modes such as streak bonuses, precision tiers, tie-breaker scenarios for tournament play, and conditional outcomes based on multi-asset rounds.

In some non-limiting embodiments or aspects, allowance-adjustment engine 1540 updates a user's Overbid Allowance or similar gameplay resource. In some embodiments, an Overbid Outcome causes deduction of a penalty amount proportional to prediction error magnitude, contest difficulty, or user-level parameters. In other embodiments, Perfect Bids or Correct-Range Outcomes restore or increase allowance amounts. Engine 1540 may also compute trade-up credits, property-acquisition multipliers, or dynamic difficulty adjustments.

In some embodiments, reward and acquisition subsystem 1550 determines whether a user acquires a property for gameplay purposes, receives a reward (e.g., coins, incentives, cosmetics, reputation points), or unlocks progression-based features. Property acquisition may depend on prediction-error magnitude, mode-specific rules, or leaderboard thresholds. Subsystem 1550 may update a persistent portfolio associated with the user.

In some embodiments, portfolio and status-update subsystem 1560 modifies user-level attributes, including player tier, ranking points, skill rating, streak indicators, and property portfolio state. The subsystem may compute composite performance metrics that influence future matchmaking, contest difficulty, or challenge recommendations.

In some non-limiting embodiments or aspects, leaderboard-update subsystem 1570 writes scoring results, rank changes, and bonus conditions to a global, regional, or cohort-based leaderboard. Leaderboards may be partitioned by geography, contest type, property class, skill tier, or event format. Subsystem 1570 may also broadcast updates to client devices in real time.

In some embodiments, behavioral-signal export subsystem 1580 transmits gameplay-derived signals—such as prediction tendencies, bias patterns, accuracy drift, and strategic behaviors—to the event-driven feedback module 150 shown in FIG. 1 and to the retraining pipelines illustrated in FIG. 14. These behavioral signals may inform model refinement, comp-selection weighting adjustments, elasticity-response tuning, and explainability-personalization logic.

In some non-limiting embodiments or aspects, audit, logging, and state-synchronization subsystem 1590 records outcome states, scoring transitions, penalties, bonuses, prediction errors, and timestamped event metadata to ensure compliance, reproducibility, and deterministic gameplay adjudication. Logged data may enable forensic reconstruction of contest rounds, dispute resolution, or training-mode simulation.

As shown in FIG. 1, Market Boss® game engine 140 corresponds to the scoring and outcome-determination architecture depicted in FIG. 15, which processes prediction submissions, computes prediction error, determines gameplay outcomes, updates user portfolios and balances, integrates behavioral signals into model-refinement pipelines, and publishes results to dissemination and output module 160.

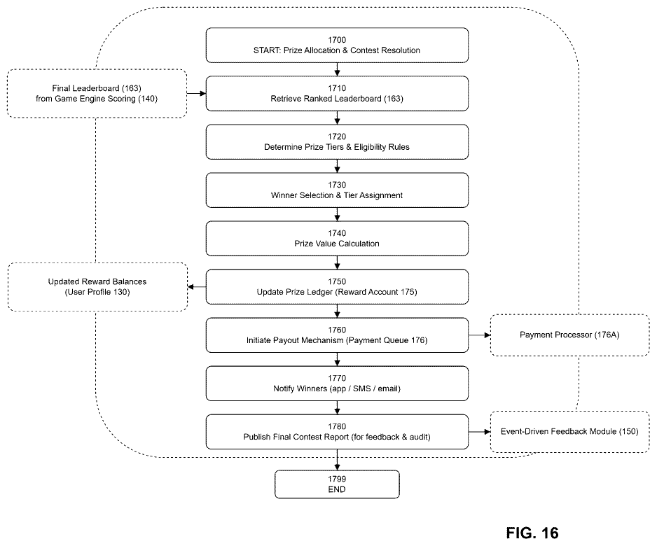

FIG. 16 illustrates a non-limiting embodiment of a prize allocation, contest resolution, and reward distribution workflow 170 executed after final scoring results are generated by the game engine scoring module 140. The workflow is initiated 1700 when all properties associated with a contest round have received verified outcome data and final user results have been posted. The system retrieves a ranked leaderboard 1710 reflecting user acquisitions, accuracy scores, remaining overbid allowances, and applicable tie-breaker metrics. Contest-defined prize tiers and eligibility rules are then determined 1720, including rank thresholds, bonus criteria, and disqualification conditions. Eligible users are assigned to corresponding prize tiers 1730 based on leaderboard position and applied business logic, and final prize values are computed 1740 using one or more bonus factors. The calculated prize amounts are recorded in a persistent prize ledger associated with each user profile 1750, thereby updating an available reward balance 175. A payout request is subsequently generated and queued 1760 for automated fulfillment via a payment processor 176A), with processing states tracked. The system further transmits prize notifications to winning users 1770 and publishes a final contest report 1780 to an event-driven feedback module 150 for audit, analytics, and fraud detection purposes, after which the prize allocation process is completed 1799.

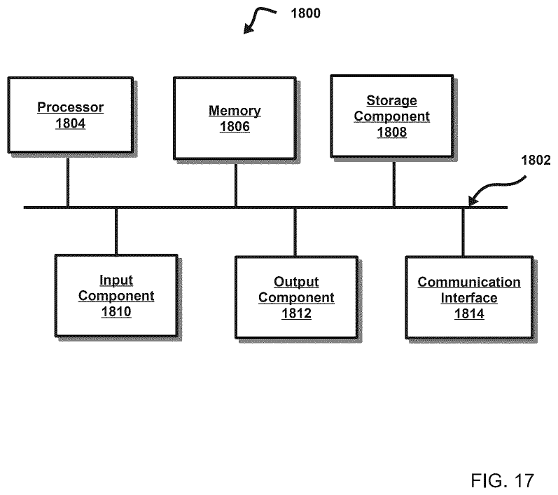

Referring now to FIG. 17, FIG. 17 is a diagram of example components of device 1700. Device 1800 may correspond to any computing system or subsystem shown in FIG. 1, including but not limited to data ingestion module 110, central AI/valuation engine 120, feature-analysis module 121, comparable-selection module 122, explainability module 123, vector-embedding database infrastructure, market boss® game engine 140, event-driven feedback module 150, or dissemination/output module 160. Device 1800 may be implemented as a cloud-compute instance, an edge-processing device, a user device, or a distributed microservice node. As shown in FIG. 17, device 1800 includes bus 1802, processor 1804, memory 1806, storage component 1808, input component 1810, output component 1812, and communication interface 1814.

Bus 1802 may include one or more components that permit communication among the components of device 1800. Processor 1804 may be implemented in hardware, software, or a combination of both. In some embodiments, processor 1804 includes one or more central processing units (CPUs), graphics processing units (GPUs), tensor processing units (TPUs), accelerated processing units (APUs), digital signal processors (DSPs), field-programmable gate arrays (FPGAs), application-specific integrated circuits (ASICs), neural-network accelerators, or other programmable execution hardware capable of running machine-learning inference, vector search, or event-driven orchestration logic.

Memory 1806 may include random access memory (RAM), read-only memory (ROM), or another type of volatile or non-volatile storage (e.g., flash, persistent memory, magnetic storage) configured to store information and executable instructions for processor 1804. Storage component 1808 may provide long-term storage of information including valuation models, embedding vectors, user interaction logs, real-estate data, game-state data, reasoning-object templates, or configuration files for orchestration module 150.

Input component 1810 may include any mechanism by which device 1800 receives information. For example, input component 1810 may comprise touchscreens, keyboards, microphones, cameras, NFC readers, QR-scanning modules, sensors, or an interface receiving property-listing feeds, image files, video frames, user predictions, or third-party MLS updates. Output component 1812 may include components that provide output—such as displays, speakers, LEDs, augmented-reality projections, or networked APIs transmitting valuation outputs, DOM curves, elasticity surfaces, structured reasoning objects, or avatar-generated video streams.

Communication interface 1814 may include a transceiver or combination of transmitter/receiver components that enable device 1800 to communicate with other devices via wired, wireless, or hybrid communication channels. Examples include Ethernet, fiber, USB-C, Wi-Fi®, Bluetooth®, Zigbee®, NFC, 5G cellular modems, WebSocket endpoints, gRPC channels, REST APIs, or publish-subscribe message brokers (e.g., Kafka®, MQTT). Communication interface 1814 may allow device 1800 to send or receive property-listing updates, embeddings, model-inference results, gameplay submissions, or event notifications.

Device 1800 may execute any portion of the processes described herein, including multimodal ingestion, feature extraction, valuation computation, DOM prediction, elasticity-surface construction, reasoning-object validation, event monitoring, recomputation triggering, or gameplay scoring. These operations may be performed by processor 1804 executing instructions stored in memory 1806 or storage 1808. A “computer-readable medium” as used herein refers to a non-transitory memory device.

Instructions may be loaded into memory 1806 or storage 1808 from another computer-readable medium or from another device via communication interface 1814. When executed, these instructions cause processor 1804 to perform any step of the workflows illustrated in FIG. 2 or the module operations of FIGS. 3-15. Hardwired circuitry may also be used in place of, or in combination with, software instructions. Accordingly, embodiments described herein are not limited to any specific combination of hardware and software.

The number and arrangement of components in FIG. 17 are exemplary. Device 1800 may include additional components, fewer components, different components, or differently arranged components than those shown. Any set of components of device 1800 may perform functions attributed to other sets of components. For example, vector-embedding search may execute on processor 1804 or on accelerator hardware connected via bus 1802. Similarly, gameplay calculations may be performed locally or remotely.

Although described in relation to real-estate valuation and prediction gameplay, device 1800 may support valuation and explainability workflows for other asset classes, including vehicles, collectibles, digital assets, equipment, insurance risks, or any domain where multimodal ingestion, machine-learning valuation, and event-driven recalculation are beneficial.

Although the disclosed subject matter has been described in detail for the purpose of illustration based on what is currently considered to be the most practical and preferred embodiments or aspects, it is to be understood that such detail is solely for that purpose and that the disclosed subject matter is not limited to the disclosed embodiments or aspects, but, on the contrary, is intended to cover modifications and equivalent arrangements that are within the spirit and scope of the appended claims. For example, it is to be understood that the presently disclosed subject matter contemplates that, to the extent possible, one or more features of any embodiment can be combined with one or more features of any other embodiment.

What is claimed is:

1. A computer-implemented method, executed by one or more processors and one or more computer-readable storage devices, for generating real-time valuations and explainable outputs for an asset, the method comprising:
ingesting, by a multimodal ingestion module, multimodal asset data comprising structured attributes, one or more images, and contextual geographic information, and transforming the multimodal asset data into a standardized internal schema;
identifying, by the multimodal ingestion module or an event-driven orchestration layer, one or more data changes or ingestion events associated with the asset, the data changes comprising at least one of: a newly posted listing, updated images, a price update, a status update, contextual attribute changes, or ingestion of a verified sale price;
notifying, by the event-driven orchestration layer, one or more downstream modules that the data changes satisfy one or more trigger conditions requiring processing;
executing, by a workflow-orchestration engine, a standardized valuation pipeline comprising:
(i) an image-analysis stage configured to generate condition indicators, room-type classifications, and visual-appeal features from the images;
(ii) a comparable-selection stage configured to retrieve embeddings from a vector-embedding database and select comparable assets using similarity metrics; and
(iii) a prediction stage configured to compute a valuation, a days-on-market (DOM) prediction, and a price-time elasticity surface;
generating, by an explainability engine, a structured reasoning object comprising explanation fields describing factors contributing to the valuation, the DOM prediction, and the elasticity surface;
validating the structured reasoning object against a deterministic reasoning schema to produce an explainable model output;
monitoring, by the event-driven orchestration layer, one or more pipeline states, data states, or model-execution conditions to determine whether an update event necessitates recomputation;
re-executing, in response to the update event, at least a portion of the valuation pipeline, including reusing stored embeddings when similarity drift satisfies a threshold condition; and
outputting, by a dissemination module, an updated explainable valuation package comprising the valuation, the DOM prediction, the elasticity surface, and the explainable model output.

2. The method of claim 1, wherein generating the embeddings comprises producing image embeddings between 256 and 1024 dimensions and text embeddings between 64 and 512 dimensions.

3. The method of claim 1, wherein selecting comparable assets comprises retrieving nearest-neighbor embeddings whose cosine similarity exceeds a configurable threshold.

4. The method of claim 1, wherein validating the structured reasoning object comprises discarding any reasoning object whose structural-consistency score falls below a predetermined threshold.

5. The method of claim 1, wherein re-executing the valuation pipeline comprises executing only those nodes whose upstream feature sets changed by more than a configured delta magnitude.

6. The method of claim 1, wherein the explainability engine generates a narrative explanation aligned to the structured reasoning object.

7. The method of claim 1, further comprising generating avatar-based video explanations using one or more narrative templates derived from the structured reasoning object.

8. The method of claim 1, further comprising updating one or more predictive models using behavioral signals from optional gameplay interactions including accuracy histories, bidding tendencies, or user-bias characteristics.

9. A system for generating real-time valuations and explainable outputs for an asset, the system comprising:
a multimodal ingestion module configured to receive structured attributes, images, contextual data, and transform the received data into a standardized internal format;
one or more machine-learning models configured to generate embeddings from the standardized internal format;
a vector-embedding database configured to store the embeddings, maintain version identifiers, and determine whether embedding reuse criteria are satisfied;
a workflow-orchestration engine configured to execute a valuation pipeline comprising
an image-analysis stage,
a comparable-selection stage, and
a prediction stage;
an explainability engine configured to generate structured reasoning objects and validate the reasoning objects using a deterministic reasoning schema;
an event-driven orchestration layer configured to detect data changes, determine whether the data changes satisfy trigger conditions, and selectively re-execute nodes of the valuation pipeline; and
a dissemination module configured to output an explainable valuation package comprising a valuation, a DOM prediction, an elasticity surface, and a validated reasoning object.

10. The system of claim 9, wherein the multimodal ingestion module enriches contextual features including market-velocity indicators, zoning boundaries, school-zone assignments, or micro-neighborhood identifiers.

11. The system of claim 9, wherein the vector-embedding database detects embedding drift using version-distance metrics and drift-tolerance thresholds.

12. The system of claim 9, wherein the workflow-orchestration engine comprises a branching controller configured to skip or execute pipeline stages based on prediction-confidence thresholds or data-completeness metrics.

13. The system of claim 9, wherein the explainability engine comprises a signal-compression module, a reasoning-synthesis module, and a narrative-alignment module.

14. The system of claim 9, wherein the event-driven orchestration layer is configured to detect competitive-listing updates within a geographic radius or similarity-based retrieval boundary.

15. The system of claim 9, further comprising a media-generation subsystem configured to synthesize avatar-based video explanations using the validated reasoning object.

16. The system of claim 9, further comprising a gameplay engine configured to compute scoring outcomes, update player balances, apply penalties for over-predictions, or award acquisitions based on verified sale prices.

17. A non-transitory computer-readable medium storing instructions that, when executed by one or more processors, cause a computing system to:
ingest multimodal asset data comprising structured attributes, images, and contextual information;
generate embeddings from the multimodal data and store the embeddings in a vector-embedding database;
execute a valuation pipeline comprising image analysis, comparable selection, valuation computation, DOM prediction, and elasticity modeling;
generate a structured reasoning object describing factors influencing the valuation outputs;
validate the structured reasoning object using a deterministic schema;
detect an update event associated with the asset or a competitive asset;
re-execute at least a portion of the valuation pipeline using at least one reused embedding when similarity drift satisfies a threshold condition; and
output an explainable valuation package comprising updated valuation information and the validated reasoning object.

18. The computer program product of claim 17, wherein the instructions cause the system to generate avatar-based video content aligned with the structured reasoning object.

19. The computer program product of claim 17, wherein the instructions cause the system to update model weights using aggregated behavioral signals from optional gameplay interactions.

20. The computer program product of claim 17, wherein the instructions cause the system to compute similarity metrics between embeddings to determine whether embedding reuse or regeneration is required.
